(19) United States
(12) Patent Application Publication
(10) Pub. No.: US 2012/0014792 A1
(43) Pub. Date: Jan. 19, 2012

(54) CIRCULATION CONTROLLED VERTICAL AXIS WIND TURBINE

(75) Inventors: James E. Smith, Bruceton Mills, WV (US); Franz A. Pertl, Morgantown, WV (US); Gerald M. Angle, II, Morgantown, WV (US); Christina N. Yarborough, Morgantown, WV (US); Andrew J. Nawrocki, Morgantown, WV (US); Jay P. Wilhelm, Morgantown, WV (US); Kenneth A. Williams, Morgantown, WV (US)

(73) Assignee: WEST VIRGINIA UNIVERSITY, Morgantown, WV (US)

(21) Appl. No.: 13/148,814

(22) PCT Filed: Feb. 9, 2010
(86) PCT No.: PCT/US10/23626

§ 371 Date: Sep. 13, 2011

Related U.S. Application Data
(60) Provisional application No. 61/159,715, filed on Mar. 12, 2009.
(60) Provisional application No. 61/159,714, filed on Mar. 12, 2009.
(60) Provisional application No. 61/159,713, filed on Mar. 12, 2009.
(60) Provisional application No. 61/159,712, filed on Mar. 12, 2009.
(60) Provisional application No. 61/151,391, filed on Feb. 10, 2009.
(60) Provisional application No. 61/151,417, filed on Feb. 10, 2009.
(60) Provisional application No. 61/151,341, filed on Feb. 10, 2009.
(60) Provisional application No. 61/151,367, filed on Feb. 10, 2009.

(51) Int. Cl. F03D 7/06; F03D 11/00; F03D 3/02

(52) U.S. Cl. 416/23; 285/61

(57) ABSTRACT

A circulation controlled vertical axis wind turbine is presented. The circulation controlled vertical axis wind turbine comprise one or more airfoils in communication with the turbine via a rotatable support shaft and an airfoil support structure. The one or more airfoils have a blowing slot disposed near the trailing edge, and a controller and control means modulates a flow of air between the blowing slot and an internal cavity of the airfoil.

### CROSS-REFERENCE TO RELATED APPLICATIONS

The present application claims the benefit of U.S. Patent Application Ser. No. App. No. 61/151,367 filed Feb. 10, 2009, entitled “Circulation and Boundary Layer Control Augmented Wind Turbine”.

The present application claims the benefit of U.S. Patent Application Ser. No. App. No. 61/151,341 filed Feb. 10, 2009, entitled “Circulation Control Augmented Wind Turbine”.

The present application claims the benefit of U.S. Patent Application Ser. No. App. No. 61/151,417 filed Feb. 10, 2009, entitled “Control System for a CC-VAWT”.

The present application claims the benefit of U.S. Patent Application Ser. No. App. No. 61/151,391 filed Feb. 10, 2009, entitled “Use of a Constant Blowing Rate Required for the Circulation Control Augmented Vertical Axis Wind Turbine”.

The present application claims the benefit of U.S. Patent Application Ser. No. App. No. 61/159,712 filed Mar. 12, 2009, entitled “Joint Assembly for Fluid Delivery”.

The present application claims the benefit of U.S. Patent Application Ser. No. App. No. 61/159,713 filed Mar. 12, 2009, entitled “Shape Memory Actuators For Air Flow Controllers”.

The present application claims the benefit of U.S. Patent Application Ser. No. App. No. 61/159,714 filed Mar. 12, 2009, entitled “Valve System for Air Flow Control in Airfoils”.

The present application claims the benefit of U.S. Patent Application Ser. No. App. No. 61/159,715 filed Mar. 12, 2009, entitled “Drag Reducing Coanda Jets for Airfoils”.

### FIELD

Embodiments of the subject matter described herein relate generally to a system and method for using circulation control to control the aerodynamic characteristics of airfoils in vertical axis wind turbines.

### BACKGROUND

Wind turbines are a source of renewable and clean energy that can be divided into two major classifications, horizontal and vertical axis. Horizontal Axis Wind Turbines (HAWTs) are similar to propellers except they are driven by the wind. HAWTs are typically located at heights approaching several hundred feet in the air. The majority of maintenance for HAWTs must be performed at these heights, making repairs and maintenance difficult. HAWTs also require being pointed in the direction of the wind for effective operation. Vertical Axis Wind Turbines (VAWTs) have an advantage over horizontal turbines since the most maintenance intensive components (generator, transmission, etc.) are located at the bottom of the turbine shaft nearer to the ground.

There are currently two significant design theories implemented in the design of both HAWTs and VAWTs to handle the fatigue and vibration issues associated with the fluctuating loads generated by varying wind conditions, especially wind gusts. The most commonly implemented design theory is a rigid design in which solid connections are made between components to counteract the fluctuating loads. These rigid connections result in localized stress concentrations which require heavier designs at the attachment points to prevent fatigue failure. The second design theory is that of a dynamically soft system in which the connection points are allowed to move via pinned or sliding connections which are then damped to prevent the system from vibrating at its natural frequencies. The use of moveable connections reduces the stress concentrations associated with rigid connections and enables a lighter wind turbine to be constructed with a longer fatigue life.

VAWTs do not have to orient in the direction of the relative wind for effective operation. However, a VAWT must adapt to changing and unsteady wind conditions to maximize energy production. Varying the blade pitch for VAWT is one method of controlling aerodynamic forces to compensate for unsteady wind and to maximize the efficiency for generating power. Unlike HAWTs, VAWTs dynamically change the blade pitch for each blade during each rotation to achieve optimum performance. The pitch change, needed during operations at for tip speed ratios (TSRs) λ<5, can approach extremes that are difficult to achieve mechanically. VAWT's are also not as popular today as HAWTs due to the perceived performance limitations created by the blade moving into the wind during a portion of its rotational path.

### SUMMARY

Presented is a system and method of using circulation control in Vertical Axis Wind Turbines, or VAWTs. Circulation control is used instead of, or in addition to, physically changing blade pitch to control the lift-drag characteristics of the blades of a VAWT. The introduction of circulation control to the turbine blade alters the performance, particularly at low tip speed ratios (λ<5) by maximizing the blades interaction with the wind in favorable locations while minimizing the wind interaction in detrimental locations along the blades' path. Circulation control also improves wind turbine power generation performance over a wide operating range of TSRs, or Tip Speed Ratios. Circulation control is further capable of reducing blade and structure stresses of VAWTs.

A Circulation Controlled VAWT, or CC-VAWT, comprises a controller to adjust blowing slots on the airfoil blades. Multiple span-wise independently controlled blowing slots, or Coanda jets, are positioned near the trailing edge of the airfoil for circulation control, and are activated individually or in concert together to modify the lifting force and/or drag characteristics of the airfoil. In some embodiments, suction ports for boundary layer control are positioned near the leading edge of the airfoil. In some embodiments the suctions ports and blowing slots act in concert to achieve the desired local aerodynamic conditions for the turbine. In some embodiments the air flow between the suction ports and blowing slots is accelerated means located within the airfoil itself. The use of various levels of blowing and suction and combinations thereof from suction ports and blowing slots disposed on the surface of the airfoil is generally called circulation control. Modulating the aerodynamic characteristics of the individual blades of the VAWT using circulation control thus results in Circulation Controlled VAWT, or CC-VAWT. The CC-VAWT uses circulation control to adjust the aerodynamic performance of each turbine blade, thus allowing the CC-VAWT to be controlled to maximize power generation over a wide range of wind speeds and environmental conditions, reduce dynamic loads during high wind conditions, and manage unsteady wind conditions.

In one exemplary method, at low tip speeds when higher ranges in angle of attack are experienced, the boundary layer suction ports delay the onset of stall, increasing the lift coefficient. In normal wind conditions, blowing slots maintain constant rotation speeds allowing the CC-VAWT to generate power at a desired frequency, such as the same frequency as an existing AC power grid. In another method, use of circulation control also enables the controller to aerodynamically brake the wind turbine, by reducing the amount of energy extracted from the wind at high tip speed ratios (λ>6), allowing for safe operation of the CC-VAWT. In another method, a constant blowing rate methodology can be implemented to simplify design decisions, facilitating implementation of CC-VAWTs in multiple locations each having different environmental conditions. The constant blowing rate can be varied from turbine to turbine resulting in a wide range of blowing coefficients as the wind speed and tip speed ratio are varied. Span-wise variation of the circulation control blowing slots enables the ability to use a constant blowing rate to limit the performance of the system, while managing the stresses in the turbine blades and their attachment points.

Valve systems located within the airfoils of the CC-VAWT that are in close proximity to the blowing slots of the trailing edge provide a means for rapid and controllable actuation of the valve system via a solenoid or other actuator. Actuators using shape memory materials have desirable weight-to-force characteristics, fast reaction times, and are capable of exerting sufficient force over a range of motion suitable for opening and closing blowing slots.

External air sources are hydraulically or pneumatically connected via conduits in the support structure and connection points. Connection points with integrated ports provide conduits for supplying air directly through the support arms and into the airfoils of a CC-VAWT. CC-VAWT that utilize the dynamically soft design methodology require flexible connections between structural elements and the connected airfoils. Connection points with integrated ports allow air to be supplied to the airfoils directly through the connection points without having to use external bypass hoses.

The circulation control system of the CC-VAWT expands the operational wind speed range of VAWTs, increasing the areas upon which wind turbines can be utilized and the percentage of time they are operating. The present invention is described in terms of wind turbines for convenience purpose only. It would be readily apparent to apply this technology to a similar device that operates in any fluid, such as hydro-electric power plants, aircraft and rotorcraft blades, or other aerodynamic or hydrodynamic surfaces.

### BRIEF DESCRIPTION OF THE DRAWINGS

The accompanying figures depict various embodiments of the system and method for using circulation control to control the aerodynamic characteristics of airfoils in vertical axis wind turbines. A brief description of each figure is provided below. Elements with the same reference number in each figure indicated identical or functionally similar elements. Additionally, the left-most digit(s) of a reference number indicate the drawing in which the reference number first appears.

FIG. 1a is an illustration of a Vertical Axis Wind Turbine;

FIG. 1b is an illustration of multiple span-wise blowing slots in one embodiment of the circulation control system and method;

FIG. 2 is an illustration of a speed (ω) & torque (τ) simplified CC-VAWT controller in one embodiment of the circulation control system and method;

FIG. 3 is an block diagram of advanced CC-VAWT controller in one embodiment of the circulation control system and method;

FIG. 4 is an illustration of the calculated performance of a CC-VAWT in one embodiment of the circulation control system and method;

FIG. 5 is an illustration of the relative velocity and angle of attack additional control capabilities in one embodiment of the circulation control system and method;

FIG. 6a is an illustration of a 2 zone blowing partition in one embodiment of the circulation control system and method;

FIG. 6b is an illustration of a 3 zone blowing partition in one embodiment of the circulation control system and method;

FIG. 6c is an illustration of a 4 zone blowing partition in one embodiment of the circulation control system and method;

FIG. 6d is an illustration of a 8 zone blowing partition in one embodiment of the circulation control system and method;

FIG. 7 is an illustration of the predicted performance of a partitioned CC-VAWT in one embodiment of the circulation control system and method;

FIG. 8 is an illustration of a momentum model predictions at solidity σ of 0.05, for the three levels of circulation control augmentation at a Reynolds number of 360,000 in one embodiment of the circulation control system and method;

FIG. 9 is an illustration of vortex model predictions at solidity σ of 0.05, for the three levels of circulation control augmentation at a Reynolds number of 360,000 in one embodiment of the circulation control system and method;

FIG. 10 is an illustration of a simulated coefficient of performance using a NACA0012 airfoil at Reynolds number of 300,000, for various solidities σ in one embodiment of the circulation control system and method;

FIG. 11 is an illustration of Schematic of an 18% Thick Elliptical Airfoil Incorporating Boundary Layer Suction and Circulation Control Blowing on its Upper Surface in one embodiment of the circulation control system and method;

FIG. 12 is an illustration of Cross-Sectional Profile of Upper and Lower, Boundary Layer Suction and Circulation Control Blowing Airfoil in one embodiment of the circulation control system and method;

FIG. 13 is an illustration of Schematic of the Piston-Type Flow Actuator in one embodiment of the circulation control system and method;

FIG. 14 is an illustration of Schematic of the Two Piston-Type Flow Actuator in one embodiment of the circulation control system and method;

FIG. 15 is an illustration of Illustration of the Support Arm Piston Air Supply Configuration for a Vertical Axis Wind Turbine in one embodiment of the circulation control system and method;

FIG. 16a is an illustration of airfoil and one Coanda jet in one embodiment of the circulation control system and method;

FIG. 16b is an illustration of airfoil and two equal strength Coanda jets producing a Kutta condition in one embodiment of the circulation control system and method;

FIG. 16c is an illustration of airfoil with two unequal strength Coanda jets creating a variable lift-drag condition in one embodiment of the circulation control system and method;

FIG. 17 is an illustration of valve system and actuators positioned within the airfoil in one embodiment of the circulation control system and method;

FIG. 18 is an illustration of valve system with an exemplary actuator in one embodiment of the circulation control system and method;

FIG. 19 is an illustration an alternative embodiment of the valve system and actuators positioned within the airfoil in one embodiment of the circulation control system and method;

FIG. 20 is a chart showing a comparison of force output vs. weight for actuators, shape memory materials, and magnetic solenoids in one embodiment of the circulation control system and method;

FIG. 21 is an illustration of exemplary shape memory alloy actuator in one embodiment of the circulation control system and method;

FIG. 22 is an illustration of the assembly of the fluid connection device in one embodiment of the circulation control system and method;

FIG. 23 is an illustration of male bracket of the fluid connection device in one embodiment of the circulation control system and method;

FIG. 24 is an illustration of female bracket of the fluid connection device in one embodiment of the circulation control system and method;

FIG. 25 is an illustration of the orientation of the ports in the fluid connection device in one embodiment of the circulation control system and method;

FIG. 26a is an illustration of an alternative pin assembly in the fluid connection device in one embodiment of the circulation control system and method;

FIG. 26b is an illustration is an illustration of the pin of the alternative pin assembly in the fluid connection devices in one embodiment of the circulation control system and method;

FIG. 27 is an illustration of variation of the blowing coefficient with respect to tip speed ratio per meter span of the turbine blade in one embodiment of the circulation control system and method;

FIG. 28 is a top view of a two-bladed vertical axis wind turbine in one embodiment of the circulation control system and method; and

FIG. 29 is an illustration of a top view of a symmetrical airfoil blade with alternative blowing slot locations in one embodiment of the circulation control system and method.

### DETAILED DESCRIPTION

The following detailed description is illustrative in nature and is not intended to limit the embodiments of the invention or the application and uses of such embodiments. Furthermore, there is no intention to be bound by any expressed or implied theory presented in the preceding technical field, background, brief summary or the following detailed description.

The use of circulation control has been applied to fixed wing aircraft since the late 1960's and early 1970's. Both, passive and active systems have been investigated. Despite the need to add a system to supply a blowing (or suction) to the blowing slots 102 for an active system, a large increase in lift has been shown. Introduction of a blown jet of air, or any fluid/gas, near a rounded surface alters the interaction between the free stream fluid/gas and the surface/object. Known loosely as flow control, in the form of boundary layer or circulation control, blowing air over the upper surface of the rounded trailing edge augments the lifting capacity of an airfoil. This concept has been shown by Kind [1968], Kind and Maull [1968], and others (including [Myer, 1972], [Englar, 1975], [Englar et al., 1996], and [Englar, 2005], to name a few.) Generally, the techniques disclosed utilize a blowing slot over the upper surface of the rounded trailing edge to augment the lifting capacity of an airfoil. A passive system, such as the use of vortex generators, has been able to provide a smaller increase in lift, but is generally used as methods to delay flow separation at high angles of attack.

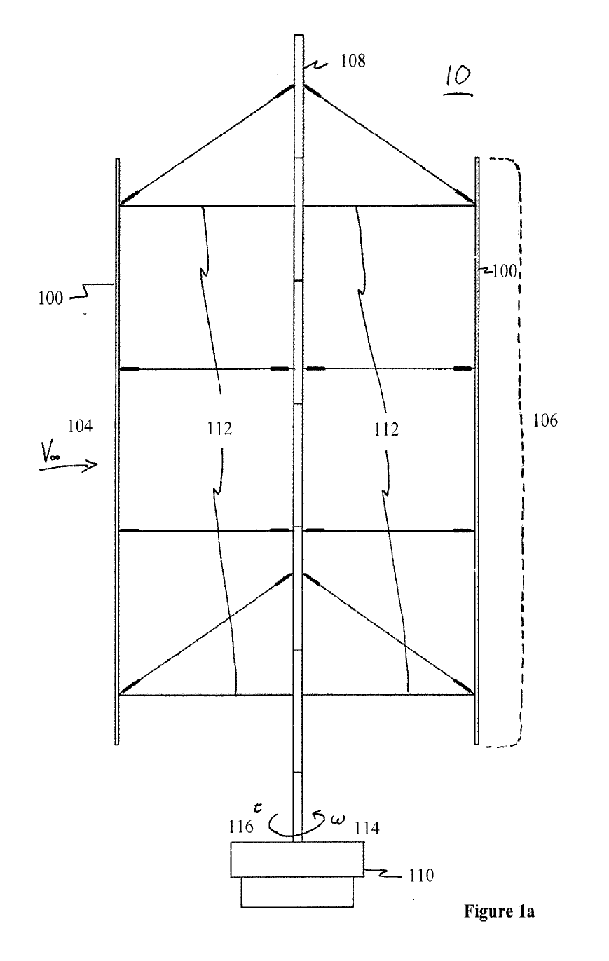

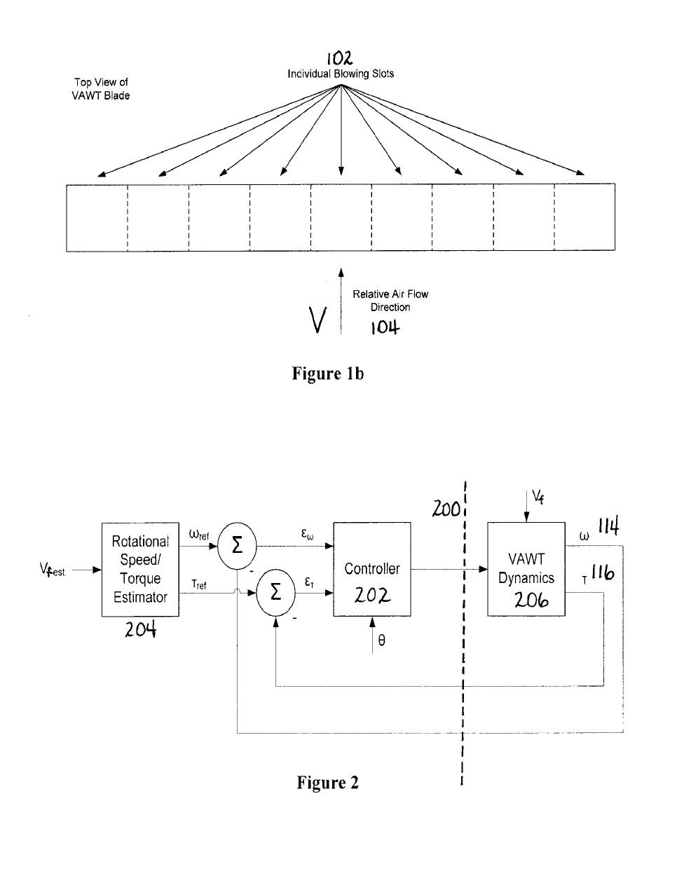

Referring now to FIG. 1a, an exemplary Vertical Axis Wind Turbine, VAWT 10, is presented. The VAWT 10 comprises a plurality of airfoils 100 or blades 100, support structures 112 that connect the airfoils 100 to the rotating main support shaft 108, and a turbine housing 110. The support structures 112 are illustrated connecting to the airfoils 100 at multiple support structure connection points, or joints, along the airfoil 100, although any number of joints, including one, are contemplated. The terms airfoil 100 and blade 100 are used interchangeably throughout this specification. The airfoils 100 each have a length called the span 106. Wind 104 across the span 106 creates lift on the airfoils 100 which is passed through the support structures 112 to the main support shaft 108 in the form of torque 116, causing the main support shaft to rotate at angular velocity ω114, hereafter also referred to as the rotational speed 114.

### Circulation Control System

Referring now to FIG. 1b, circulation control increases the airfoil 100 bound circulation to increase lift. Circulation control is implemented in the embodiment of FIG. 1b. using one or more blowing slots 102 in surface of the airfoil 100 to blow a high-velocity jet of air over a rounded surface, inducing the Coanda effect. The use of circulation control enhances the lift produced by an airfoil 100. Application of circulation control to a VAWT, or CC-VAWT, enables the creation of more lift, resulting in more torque generation from the VAWT. In one embodiment circulation control is used to modulate the aerodynamic characteristics of fixed CC-VAWT turbine blades 100 during operation thus eliminating the need to rotate or pitch the turbine blades 100 during operation. In another embodiment, circulation control is used to enhance the operation of traditional mechanical mechanisms for pitching the turbine blades 100 to maximize performance while minimizing the complexity of the actuators. In one aspect, traditional actuators are used to provide slower, gross movement of the turbine blades 100 while circulation control is used to manage transient conditions and maximize the torque 116 generated by the blades 100.

In one embodiment circulation control is implemented using multiple span-wise blowing slots 102 with independent valve control on the CC-VAWT airfoil(s), for example a NACA0018 airfoil 100 cross-section. This airfoil 100 cross-section is given only as an example and the circulation control strategies can be applied to any aerodynamic shape. In embodiments the CC-VAWT has one or more airfoils 100 incorporating the active circulation control through blowing slots 102. In embodiments, the blowing slots 102 in each airfoil 100, or turbine blade are selected by one of ordinary skill in the art to provide the desired performance. The blowing slots 102 in the embodiment depicted are located on the trailing, leading, top and bottom areas of the airfoil 100. The valve system 1202, shown in FIG. 12 and described in detail later, for each blowing slot 102 is located in the vicinity of the blowing slot 102, and inside of the airfoil 100 or as part of the blowing slot 102 itself. The valve 1204 may be either digital (fully open, or fully closed), analog (any state from fully open to fully closed), or any combination thereof. In embodiments, the valve 1204 is opened or closed by any suitable means whether mechanical, electrical, electro-mechanical, hydraulic, pneumatic, a thermally actuated device, or an equivalent means as would be known in the art.

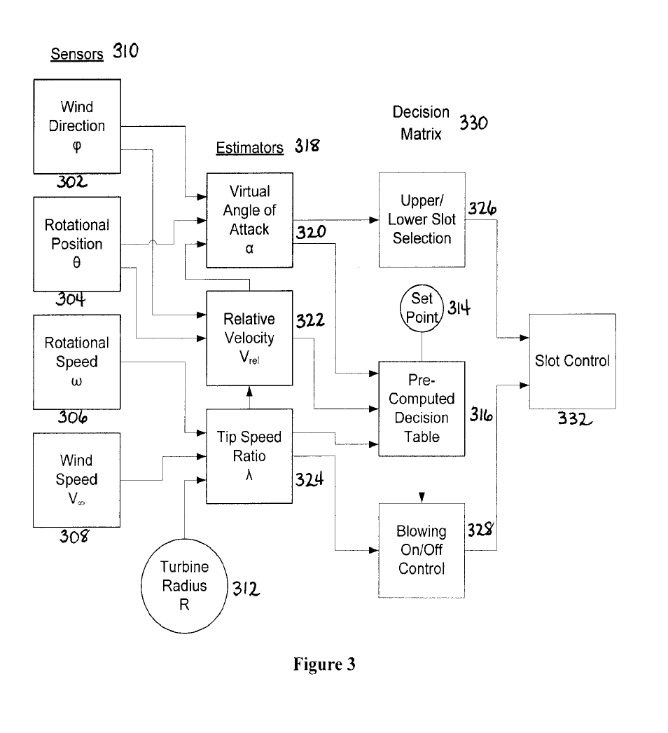

To optimize the turbine performance, the valve 1204 has response time requirements dictated by the maximum rotating speed 114 ωₘₐₓ and circumference, or radius 312 (R), of the CC-VAWT. FIG. 3 depicts sensors and parameter inputs to a control system corresponding to these values. The response time of each valve 1204 is rapid enough to allow for multiple openings and closings per revolution, as well as pulsed or frequency controlled blowing. Pulsing the circulation control system in lieu of constant blowing provides the ability to reduce the mass flow rate of air, or other fluids, required to be passed through the blowing slot while maintaining the ability to augment the lift generated, and allow for finer control over the amount of lift force being generated by varying the pulsed frequency, pulse duration, or inter pulse interval of the circulation control blowing.

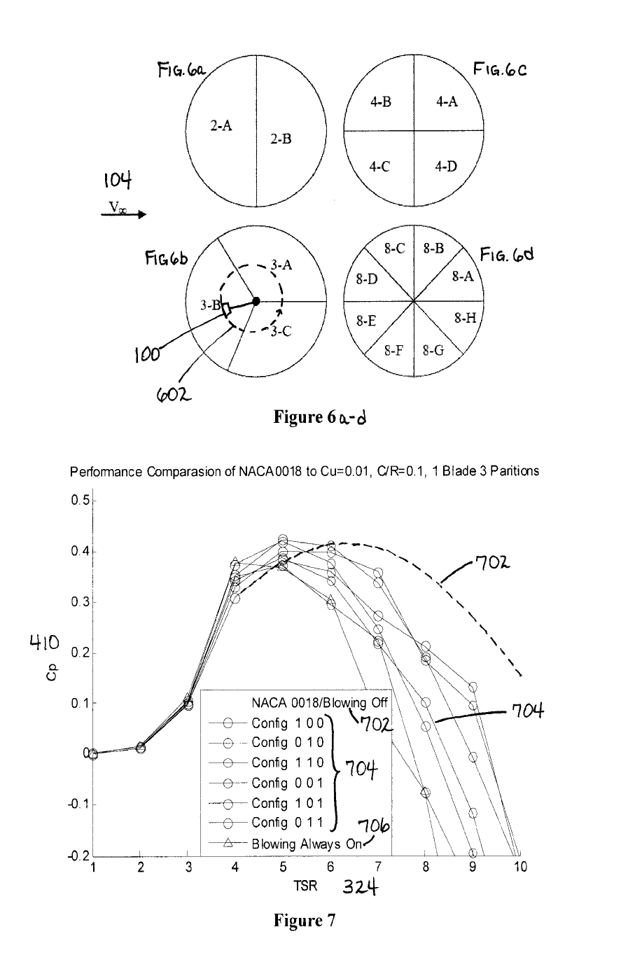

In one embodiment, a turbine blade 100 with independently controllable sites of actuated blowing slots 102 is incorporated on a VAWT. A planer form view of an example blowing slot 102 distribution is shown in FIG. 1b. This configuration of blowing slots 102 is for convenience purpose only. In embodiments, the blowing slots 102 are controlled many times during a rotation, shown in the diagram of FIG. 6, with different span-wise distributions or patterns, in a single uniform span-wise distribution, or in an always-on or always-off state. A CC-VAWT incorporating the always-on blowing control shows improvement in the coefficient of performance over a standard VAWT of similar geometric and atmospheric specifications, especially at moderately low TSRs 324, or Tip Speed Ratios shown as a calculated value derived from sensor 310 inputs in FIG. 3. In embodiments, the control over the blowing slots 102 is homogenous over the entire span 106 of the blade 100, but different for each position along the rotational path 602 of the turbine blade 100. This produces a blade 100 that is either in a high lift (blowing on), standard lift region (blowing off), or reduced lift (blowing on opposite surface)—with blowing slot 102 changes coordinated with the phase of rotation.

FIG. 2 depicts a block diagram of a CC-VAWT with integrated controller 202. The amount of power that a CC-VAWT generates is the product of torque generated (τ) 116 and the rotational speed (ω) 114, and is limited by a maximum wind energy extraction efficiency commonly known as the Betz Limit. The highest efficiency of extracting the energy available in the natural wind 104, according to the Betz limit, is a coefficient of performance (Cₚ) 410 of 16/27(˜0.59). At this theoretical maximum Cₚ 410 the average downstream velocity is 1/3 of the upstream velocity. The addition of circulation control to a VAWT cannot violate the Betz limit, but through the use of the controller 202, a VAWT approaches this limit at a larger range of wind speeds 308.

In an embodiment, multiple independently span-wise 106 blowing slots 102 are disposed along the span of the blade 100 and controlled to improve performance, manage upper and lower blowing, and reduce blade and structure stress using advanced control techniques. In embodiments, each blowing slot 102 is synchronized with other blowing slots 102 or activated asynchronously for other blowing slots 102 located on the same blade 100 or different blades 100. One embodiment of the controller 202 is shown in FIG. 2. The controller 202 functions on any type of a VAWT and is presented in this disclosure for a straight-bladed Darrieus turbine as an example only. In other embodiments, control with specific modifications is applied to a HAWT or any rotary device which employs circulation control, and requires a different distribution and scheduling of the blowing slots 102. In other embodiments, the control is to turbines operating in different fluid media such as water.

Circulation control maximizes overall power generation, while reducing the blade 100 and structural stresses, improving startup characteristics, and providing the ability to decrease power uptake during excessive wind 104 conditions. In a first mode, circulation control increases performance through scheduling of blowing and increased jet velocity through the blowing slots 102. This mode increases power generation over a typical VAWT by enhancing the lift force via circulation control. In a second mode, circulation control assists with turbine rotational startup. Achieving a TSR 324 (λ>1) is an issue with some VAWT's due to a limited and potentially negative torque 116 (τ) generated at low rotation speeds. In this second mode, circulation control assists by boosting the lift coefficient at low wind speeds 308 using a circulation control blown jet. Circulation control is typically more effective with high levels of blowing and low wind speeds 308 according to analytical models. In a third mode, circulation control modifies the configuration of the blowing slots 102 to decrease the lift force, reducing the rotational speeds 114 and/or torques 116 generated at wind speeds 308 that would otherwise be unsafe for operation of the turbine.

Referring now to FIGS. 2 and 3, block diagrams of a simplified CC-VAWT control system 200 and an advanced CC-VAWT control system 300 are presented. Control systems 200, 300 use environmental and performance parameters as well as physical information about the turbine itself to determine when to activate the blowing slots 102. In various embodiments, sensors 310 provide wind speed 308 (instantaneous and averaged, one, two, and three axes), wind direction 302 (instantaneous and averaged), turbine rotational speed 114 and instantaneous blade rotational position 304. In some embodiments additional sensor information or calculated values are used such as blade stress and force information (static, continuous, maximums, measured, and/or calculated), pressure and mass flow information about the blowing slot 102 air, blowing slot 102 valve response time, and the pre-determined performance and physical data or parameters about the wind turbine, such as the turbine radius 312. In embodiments, some or all of these parameters are estimated by the controller 202.

In FIG. 2, a block diagram of the simplified CC-VAWT system 200 is presented. An estimator 204 produces desired speed ω_{ref} and torque τ_{ref} commands based on the wind velocity 104. The desired speed ω_{ref} and torque τ_{ref} are combined with feedback measurements 206 from the measured output of the VAWT to produce error signals that the controller 202 uses to determine when to activate the blowing slots 102. This information flow is given as an example, and it should be understood by anyone knowledgeable in the art that in other embodiments, additional information and inputs, such as atmospheric pressure, relative humidity and temperature, can also readily be incorporated into the controller 202. to achieve the predetermined set point 314

In FIG. 3, an expanded view of the information flow conducted within the advanced CC-VAWT control system 300 is shown. The advanced CC-VAWT control system 300 breaks apart the functional roles of components of the controller 202 into estimators 318 and a decision matrix 330, however in various embodiments the controller 202 should be generally understood to encompass a subset of superset of elements of the estimators 318 and a decision matrix 330.

In embodiments of the advanced CC-VAWT control system 300, sensor 310 inputs are converted to the desired system state variables by suitable state estimators 318 incorporated into the CC-VAWT control system 300. In embodiments, estimators 318 estimate the virtual angle of attack 320 of the blade 100, the relative velocity 322 of the blade 100 in relation to the wind 104, and the tip speed ratio, or TSR 324. Using these estimates from the estimators 318, a decision matrix 330 signals the slot controller 332 to activate the appropriate blowing slots 102. In one embodiment, the decision matrix 330 comprises an upper/lower slot selector 326, a blow level controller 328, a slot controller 332, one or more pre-computed decision tables 316 and a predetermined set point 314 for activating the blowing slots 102. In the embodiment presented in FIG. 3, the upper/lower slot selector 326 of upper or lower blowing slots 102 is based on the estimated angle of attack 320, and the blow level controller 328 determines the level based on both TSR 324 and inputs from the pre-computed decision tables 316. In other embodiments, valve 1204 actuations for activating the blowing slots 102 are computed in real time using, for example, a processor adapted for determining when to activate the blowing slots 102 for a dynamic range of conditions and desired power generation from the CC-VAWT. The decision matrix 330 computes the level of the blow level controller 328 and which blowing slots 102 to utilize for desired performance from the CC-VAWT.

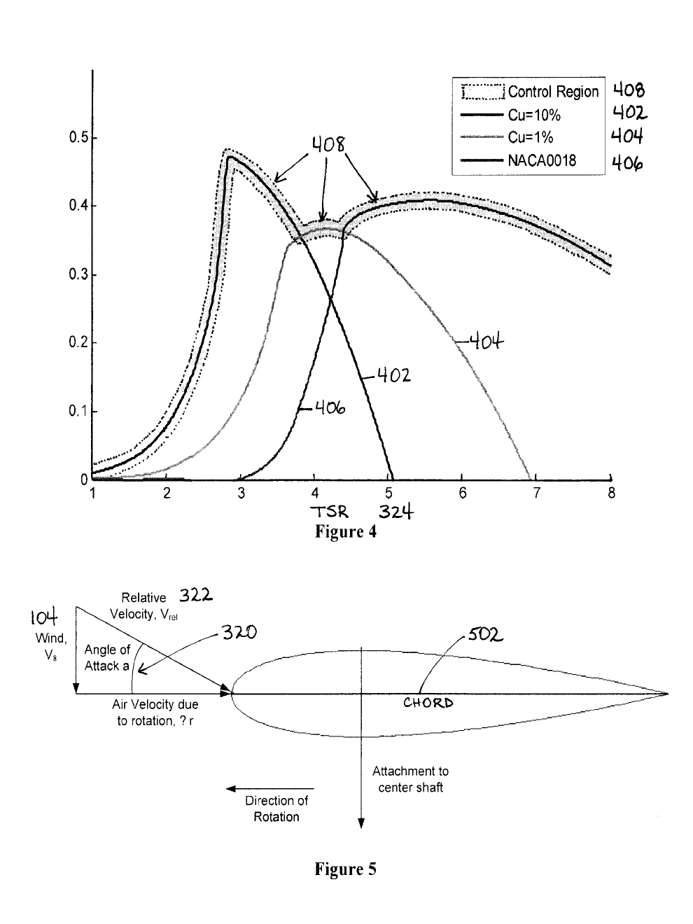

In embodiments, the decision matrix 330 is based upon any combination of experimental, simulated, and historical performance data of the specific CC-VAWT. Referring now to FIG. 4, the performance capabilities of a particular wind turbine at different tip speed ratios 324 and different blowing coefficients, Cμ 412, is shown graphically. This information is generated using computer performance simulations of the capabilities of a CC-VAWT blade using a chord to radius ratio of 0.05. In this case, the performance characteristics are determined for a NACA0018 airfoil 406 without blowing, a NACA0018 airfoil 408 with a blowing coefficient, Cμ 412, of 10% 402 and a NACA0018 airfoil 406 with a blowing coefficients, Cμ 412, of 1% 404. From these data, a control region 408 is developed for producing a high coefficient of performance, Cₚ 410, over a wide range of TSRs 324.

The data is used by the decision matrix 330 and augmented with the environmental and performance measurements from the sensors 310 and estimators 318. The decision matrix 330 determines the blowing and non-blowing state of the circulation control jets, or blowing slots 102, to obtain a desired goal such as a high coefficient of performance, Cₚ 410. The decision matrix 330 also adapts to varying situations such as large or small changes in wind speed 308 and wind direction 302, and blowing slot 102 or valve 1204 failures.

Referring now to FIGS. 3 and 5, the upper/lower slot selector 326 selects which of the blades' 100 upper and lower (or turbine inner and outer) blowing slots 102 are activated. The virtual angle of attack 320 estimator 318 determines the apparent angle of attack 320 of the blade 100, with respect to the relative velocity 322 (vector sum of the rotational speed 114 and wind velocity 308). To enhance the turbine performance, for a negative apparent angle of attack 320 the lower blowing slot 1208 is used and vice versa for the upper blowing slot 1206. The apparent angle of attack 320 is determined by the relative velocity 322 estimator 318 and is a function of the wind speed 308 and wind direction 302, rotational speed 114 and blade rotational position 304. Also, used to determine the virtual blade angle of attack 320 is the static dimension parameters of the wind turbine, such as the radius 312 and the blade 100 chord 502 and span 106.

In addition to the control of the upper blowing slot 1206 and lower blowing slot 1208 for proper angle of attack 320 selection and to maximize power, circulation control is used to reduce performance. In some cases a reduction in performance, which is a reduction in torque, is beneficial to a wind turbine. Excessive rotational speeds 114 or wind speeds 308 can have the potential to damage a turbine. Circulation control, when used fully or intermittently during rotation or in sections along the blade span 106, in known wind speeds 308 and rotational speeds 114 can reduce lift produced by the blade 100 and in turn reduce or shutdown power production. In other embodiments, this reduction in power is used to match an electrical or mechanical load being driven by the turbine.

Referring now to FIGS. 6a, 6b, 6c, and 6d, the turbine's rotation is divided into partitions 2-A, 2-B; 3-A, 3-B, 3-C; 4-A, 4-B, 4-C, 4-D; 8-A, 8-B, 8-C, 8-D, 8-E, 8-F, 8-G, 8-H; or collectively, zones. In FIG. 6b, a CC-VAWT with one blade 100 rotates through the three zones labeled 3-A, 3-B, and 3-C on a circular path 602. In various other embodiments, the path 602 of the rotation is broken into any number of zones. FIG. 7 illustrates the coefficient of performance Cₚ 410 for the three-zone rotation of the turbine of FIG. 3. The coefficient of performance Cₚ 410 varies in each states of conditional zone blowing 704, always on blowing 706, and no blowing 702. Using zones provides a method of selecting a desired performance level for the wind turbine, and facilitates controlling the degradation of the performance level between the always on blowing 706 and no blowing 702 states.

In another embodiment, reduction of blade stresses or forces on a CC-VAWT is achieved by reducing the lift force in certain sections of the rotational path 602, depending upon the rotation speed 114, wind direction 302, wind speed 308, and disturbances or changes to the wind speed 308 and wind direction 302. Parts of the CC-VAWT that benefit from a reduction in stress are determinable by detailed machine analysis, and include such areas as the joint(s) between the blade 100 and the support structure 112. In addition, the areas of stress reduction include the entire wind turbine, with emphasis on the blades 100, support structure 112 for the blades 100, and the main support shaft 108. The stresses in blades 100 and support structure 112 for the blades 100 are reduced by controlling, reducing or enhancing, the aerodynamic forces that are generated using circulation control.

The forces on a blade 100 are not uniform during the rotation of a VAWT which will want to cause the rotating structure to vibrate and or to wobble about the main support shaft 108 of the turbine. Because of this the rotating main support shaft 108 experiences cyclic loading and fatigue. The CC-VAWT with circulation control balances out, or smoothes the forces generated during rotation to reduce this cyclic stress.

The power generated by a CC-VAWT may either be used in mechanical or electrical form. This power may be controlled to develop under a constant level of torque 116, or rotational speed 114, or in a desired range of these two variables. In one embodiment, electrical power require a constant rotational speed 114 with varying or constant levels of torque 116 in order to generate a constant frequency compatible for insertion of power into a fixed frequency AC electrical power grid. In this embodiment the CC-VAWT controller presides over a power-conditioning unit that handles electrical power conversion and generation, reducing the number of components required to integrate a wind turbine to the electrical grid.

In one embodiment, the implementation of the CC-VAWT controller is realized with software running either real-time or scheduled, written in a single or combination of programming languages commonly known in the arts, such as but not exclusively C, C++, JAVA, C#, Visual Basic, Assembly, MATLAB, ADA. In embodiments, the hardware is a PC or micro-controller, or other types of controller/computing hardware. In embodiments, the hardware uses x86, x86-64, RISC, or ARM processors. In embodiments, the hardware uses any number of digital inputs, digital outputs, analog inputs and/or analog outputs. This hardware may also comply with standardized, ad-hoc, or proprietary serial and parallel data transfer methods and protocols.

In embodiments, the software of the controller uses Artificial Intelligence (AI), classical control techniques, non-linear control techniques, and/or any combination of control techniques commonly known in the arts. In embodiments, the AI system may be comprised of Fuzzy Logic, Neural Networks, Genetic Algorithms and/or any combination of these methods in any manner.

In embodiments, the controller uses a sensor 310 or a plurality of sensors 310 to compute the environmental parameters of wind speed 308 and wind direction 302, and bases decisions on either instantaneous and/or averaged values. In embodiments, the controller uses one or more filters and/or neural networks to estimate the wind speed 308 and wind direction 302 based upon data from wind speed sensors 308, such as anemometer(s), wind direction sensors 302, such as wind vane(s), rotational speed sensor(s) 306, force sensor(s), on the blade(s) 100, support structure 112 and rotating main support shaft 108, a torque sensor(s) located on the main support shaft 108, and/or power output from turbine. In embodiments, the power levels produced by a particular CC-VAWT are estimated by software to control the blowing slots 102. In embodiments, the sensors 310 are analog or digital and output the sense on analog, digital, or serial or parallel communication paths. In embodiments, the communication paths may be wired, wireless, or optical.

### Circulation and Boundary Control

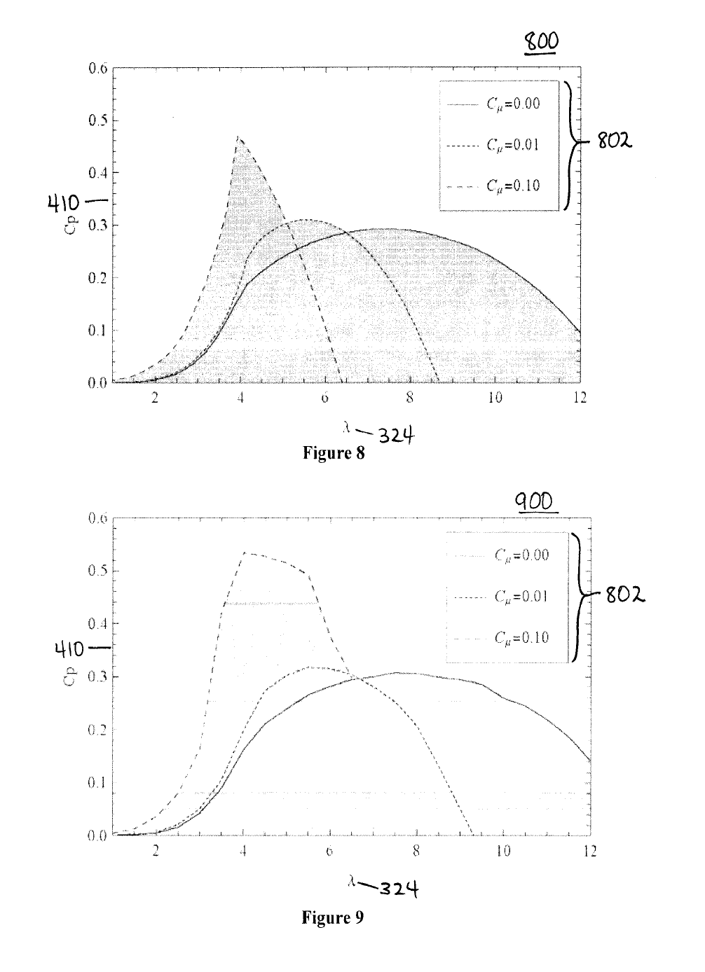

The addition of circulation control to the airfoil 100 of a vertical axis wind turbine blade makes a vertical axis wind turbine (VAWT) appear to have a higher solidity factor 1000, σ, than the physical shape indicates. Referring now to FIGS. 8 and 9, performance projections are illustrated for constant blowing coefficient values 802 applied throughout a range of tip speed ratios 324 using the momentum models 800 and vortex models 900. The momentum models 800 and vortex models 900 are illustrated for blowing coefficients, Cμ 412, of 0.00, 0.01, and 0.10 used as the constant blowing coefficient values 802. For each of the constant blowing coefficient values 802, increasing the blowing coefficient considerably increases the coefficient of performance Cp 410 at tip speed ratios 324 less than six, enabling CC-VAWT at these lower tip speed ratios 324.

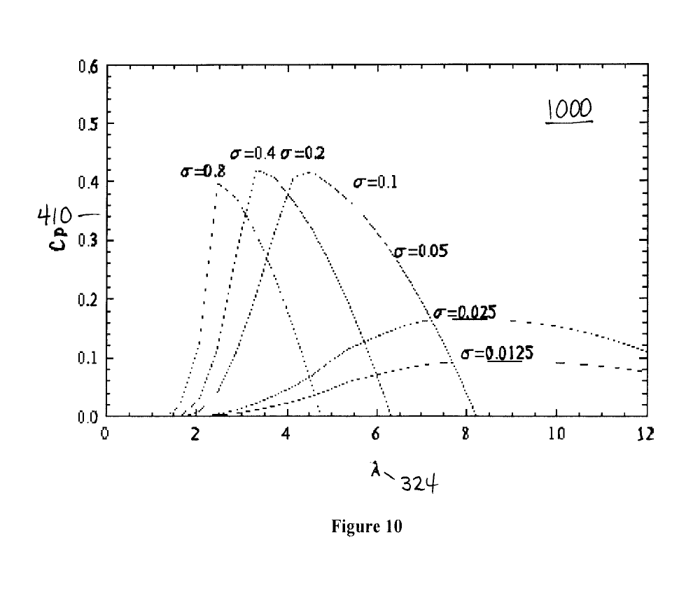

Referring now to FIG. 10, an illustration of the coefficient of performance Cp 410 for a range of tip speed ratios 324 is presented for a plurality of solidity factors 1000, σ. Comparing the circulation control performance of FIGS. 8 and 9, with the solidity factor 1000, σ, performance of FIG. 10, it is seen that the use of circulation control resembles increasing the solidity factor 1000, σ. Circulation control augmentation is different than solidity factors 1000, σ, in that circulation control varies with respect to the blade rotational position 304, the blowing slot's 102 span-wise 106 location on the blade 100 and as a function of the wind speed 308. In circulation control, this variation is achieved through a computer-based controller 202 to optimize and condition the power output. In embodiments, other control methods known in the arts, e.g. mechanical or electronic controller, are implemented in the controller 202.

In embodiments, boundary layer control is used enhance the aerodynamic performance of the wind turbine blades 100. In embodiments, boundary layer control is used instead of, or in addition to, using the circulation control using blowing slots 102. Boundary layer control achieves a delay in the separation of the flow of air (i.e., fluid including gas, water, etc) from the surface of the blade 100, thereby achieving higher angles of attack 320. In embodiments, boundary layer control is based on either active or passive (powered/unpowered) systems to change the near surface characteristics of the flow of air over an airfoil 100.

A passive system, such as the use of small scale vortex generators, increases the mixing of free stream energy into the boundary layer. This increased mixing adds energy to the flow near the surface of the airfoil 100, resulting in a delay in the flow separation, i.e., enabling the ability to generate lift at higher angles of attack 320. An active system is similar to circulation control in that it adds energy to the boundary layer that delays the separation, but does not occur in the vicinity of a rounded trailing edge. Another active boundary layer control technique is to utilize suction to remove the low energy (speed) fluid near the surface of the body.

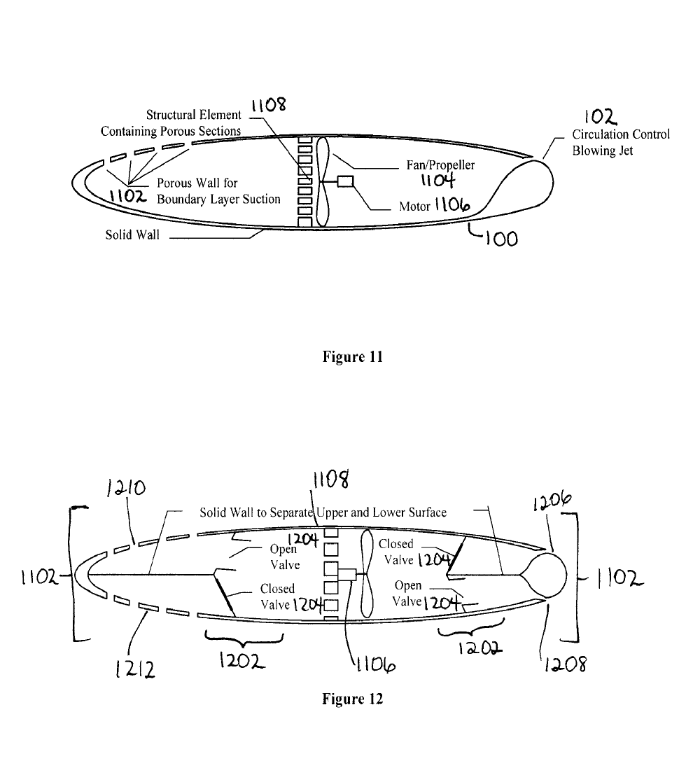

Referring now to FIGS. 11, 12, 13, and 14, in embodiments, boundary layer suction is combined with circulation control blowing. In one embodiment, a perforated or porous surface over a portion of the blade 100, non-dimensionalized with the length of the chord 502 and from 0.05<x/c<0.5, creates one or more suctions ports 1102 that are pneumatically (or hydraulically) connected to the circulation control blowing slot(s) 102. The circulation control blowing slots 102 are located near the trailing edge from 0.75<x/c<1−Dₜₑ/2c. The upper bound on the trailing edge blown slot is based on the diameter of the trailing edge, Dₜₑ, and the chord 502 length of the airfoil 100, and thus are located the distance equivalent to the trailing edge radius from the trailing edge of the airfoil 100.

The use of a combination of suction ports 1102 and blowing slots 102 is applicable to any airfoil 100 or hydrofoil shape, and is shown on an 18% thick elliptical airfoil for convenience only. The air/hydrofoil, henceforth referred to as airfoil 100, incorporates a rounded trailing edge, with a diameter between 0.4 inches and 0.6 times the thickness of the airfoil (e.g., if the airfoil is 3 inches thick, the diameter of the trailing edge could be as large as 1.8 inches). The modification of the trailing edge of the airfoil 100 creates a Coanda surface that facilitates the flow control phenomenon, or Coanda effect, being utilized with the circulation control blowing.

In the embodiment depicted in FIG. 11, the porous surface suction ports 1102 and blowing slot(s) 102 are illustrated in the upper surface of the airfoil 100. In embodiments the suction ports 1102 and blowing slot(s) 102 are located on the upper surface, the lower surface, or any permutations of upper and lower surfaces of the airfoil 100. Referring now to FIGS. 12 and 14, the airfoil 100 may also be divided into multiple regions (i.e., upper and lower sections) for part or all of the chord 502. Referring now to FIG. 12, in one embodiment a valve system 1202 and associated valve 1204 enables boundary layer suction on the lower surface and circulation control blowing over the upper surface of a rounded trailing edge through the use of a valve system 1202. By opening and closing the appropriate valves 1204, air from the upper suction port 1210 is directed to either the upper blowing slot 1206 or the lower blowing slot 1208, or a combination of the upper blowing slot 1206 and lower blowing slot 1208. Similarly air from the lower suction port 1212 is directed to either the upper blowing slot 1206 or the lower blowing slot 1208, or a combination of the upper blowing slot 1206 and lower blowing slot 1208.

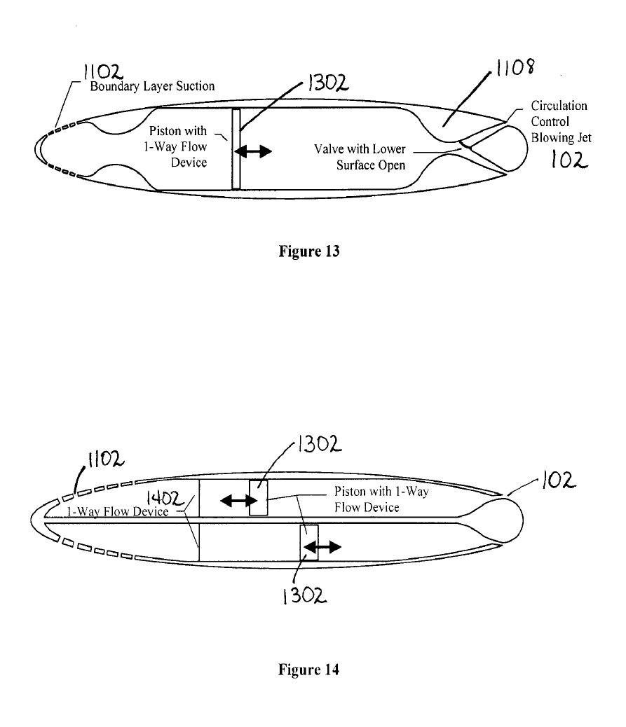

The fluid dynamic surface is supported with at least one internal structural element 1108. In embodiments, the internal structural element 1108 provides rigidity to the blade 100 and is solid (not shown) or porous (shown in FIGS. 11 and 12) depending on its location and orientation. These internal structural elements 1108 may be in the span-wise 106, chord-wise 502, or in the thickness direction, as well as in composite directions, combining more than one of the three primary directions. Though illustrated in FIG. 11 and FIG. 12 as attaching the interior of the upper surface to the interior of the lower surface, the internal structural elements 1108 are not required to connect opposite surfaces. Referring now to FIG. 13, an illustration of a reinforcing internal structural element 1108 that does not connect the two surfaces together is presented. Referring now to embodiments depicted in the cross-sectional illustrations of FIGS. 11, 12, 13, and 14, the internal structural elements 1108 may also not span the entire length of the airfoil 100 or similar fluid dynamic surface being constructed, and hence sections of the surface may be solid (without the blowing/suction augmentation) and provide additional structural support to the regions where blowing/suction is utilized.

In embodiments, the airfoil 100 contains more than one internal structural element 1108, each of which may or may not contain porous sections. For example, there may be sections of a blade 100 or wing where the augmentation of boundary layer suction and/or circulation control blowing is not desired, thus the porosity is not needed. It may also be desired to separate the upper surface from the lower surface, such that suction/blowing can occur on both the upper and lower surface simultaneously, independently, or in an overlapping manner. For example, during the transition from upper surface to lower surface flow control it may be beneficial to have both systems activated at the same time. The separation of the upper and lower zones of flow control enables the variation in mass flow rates, i.e., the upper surface flow control may be set at a different jet velocity/momentum than the lower surface. The variation in performance can also be achieved by placing a pressure regulator between the suction ports 1102, blowing slots 102 and the activation system (fan 1104, piston 1302, or similar) near the valve 1204 to activate each respective region of the airfoil 100, hydrofoil, or similar device.

In embodiments, the connection between the two active flow control elements, the suction ports 1102 and blowing slots 102, includes a means to accelerate air, or similar gas or liquid. In embodiments, the means is a fan 1104, impeller, or other mechanical flow accelerating device placed inside the turbine blade 100. In one embodiment the fan 1104 is placed near the location of maximum thickness of the blade 100 to provide the greatest area upon which the fluid can be accelerated. The fan 1104 is powered by a motor 1106 and orientated such that air is drawn or forced from the suction ports 1102 toward the circulation control blowing slots 102. The controller 202 determines when the valves 1204 of the valve system 1202, and the fans 1104 are activated. The motor 1106 is shown on the right hand side of the fan 1104, but in alternate embodiments is attached to the left as shown in FIG. 12 or embedded into the structural element within the airfoil 100 cavity.

Referring now to FIGS. 13, and 14, in other embodiments the means to accelerate the air or fluid is a piston 1302. The piston 1302 provides a pressure gradient pulling the fluid near the suction ports 1102 and sending it out of the blowing slot 102. In embodiments, the use of a piston 1302 includes mechanisms to relieve pressure when returning to the piston's 1302 useful position. Referring now to FIG. 14, in a first embodiment one or more one-way pressure devices 1402, for example check valves, release when the piston 1302 is traveling right to left. In a second embodiment, a bypass channel sends the excess pressure either to another section of the airfoil 100 or to the opposite side of the piston 1302.

In one embodiment, a fan 1104 powered by a motor 1106 or similar means, is the supply mechanism to attach two regions of boundary layer suction to two circulation control blowing slots 102. It is also possible to use a single piston 1302 configuration in this manner. The suction and blowing may be linked either together (i.e., upper-upper) or opposite (i.e., upper-lower, as shown in FIGS. 12 and 14) as well as with both suction ports connected to one blowing slot 102, or vice versa, and potentially with all four valves 1202 open at once. FIG. 14 shows a two piston configuration to provide control over the upper-upper and lower-lower linked suction port 1102 and blowing slot 102. It is also possible to use a two fan 1104 configuration in this manner.

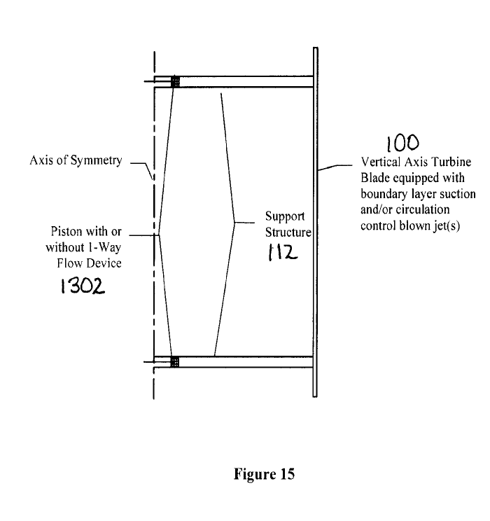

Referring now to FIG. 15, another potential source of air for either circulation control blowing or boundary layer suction, for applications, such as a vertical axis wind turbine, is to place a piston 1302 in the hollow support structure 112 of the blade 100. The piston 1302 utilized in this configuration can either incorporate the one-way pressure device 1402 or provide alternating suction and blowing to the blade 100. In embodiments, this alternating pressure gradient is used in conjunction with a mechanism to select between the blowing slot 102 and the boundary layer suction port 1102 on the augmentation equipped surface.

### Circulation Control Using Coanda Jets

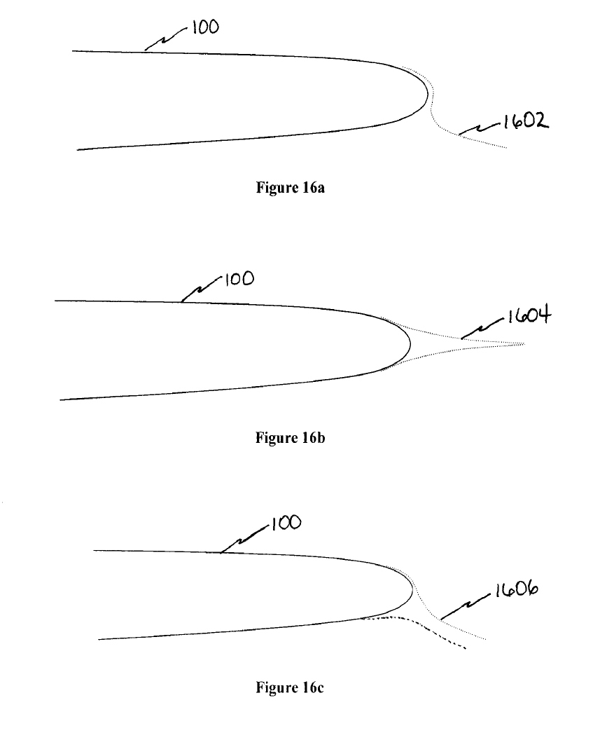

Referring now to FIG. 16a and FIG. 12, a blowing slot 102 is used to blow a stream of fluid, such as air, over the upper surface of an airfoil 100 having a rounded trailing edge. This blown stream of fluid produces an effect, known as the Coanda 1602 effect, that augments the lifting capacity of the airfoil 100. Referring again to FIGS. 12, 13, and 14, in other embodiments of the present disclosure, a second blowing slot 102 is added to the lower surface of the trailing edge of the airfoil 100. The addition of the second blowing slot 102 to the trailing edge of the airfoil 100 results in expansion of the lift augmentation capability, allowing the inversion of the direction of the lifting force and/or creating a lower drag scenario without physically altering the airfoil. In one embodiment, the upper and lower blowing slots 102 are separately controllable, allowing the lift performance to be biased in one direction by using different blowing rates in the two slots 102. For example, on a helicopter main rotor it may be desirable to increase the upward force during part of the blades' 100 rotational path 602 and reduce, but not invert, the force in another portion of the rotation.

Referring now to FIG. 16b, and continuing to refer to FIGS. 12, 13, and 14, in another embodiment, in addition to using a blowing slot 102 to blow a jet over one surface, either upper or lower, air is blown out of both blowing slots 102 simultaneously. If the jet blowing rate out of the two blowing slots 102 are the same then a stagnation point is created slightly downstream of the trailing edge of the airfoil, called a Kutta 1604 condition. A Kutta 1604 condition, when used in lieu of turning the circulation control blowing off, reduces the profile drag of the aerodynamic structure by reducing the size of the wake created by the airfoil 100.

Simultaneously opening the upper and lower blowing slots 102 diminishes the lift enhancing capabilities of the Coanda 1602 jets by producing a Kutta 1604 condition, but this Kutta 1604 configuration enables a drag reduction when compared to the un-blown, rounded trailing edge. Thus, when the lift augmentation is not needed the drag penalty of the rounded trailing edge can be reduced considerably. In a vertical axis wind turbine, or VAWT, for a portion of each blade's rotational path 602 the addition of lift is not beneficial. In those portions of the rotational path 602, opening both the upper and lower blowing slots 102 reduces the blade's 100 drag. Reducing drag on one blade enhances the amount of torque 116 available to the vertical access wind turbine (VAWT) from the other blades 100.

Referring now to FIG. 16c, and continuing to refer to FIGS. 12, 13, and 14, in other embodiments, variably controlling the blowing rates out of each blowing slot 102 to produce Coanda 1602 jets enables a lower drag scenario as well as lift augmentation capability. This variable lift-drag 1606 condition is shown in FIG. 16c and illustrates the potential to use different blowing coefficients, Cμ 412, out of each blowing slot to augment the lift created while also providing a reduction in drag. The difference in blowing coefficients, Cμ 412, on the upper and lower surfaces can be used to augment the lift and drag forces at different levels.

There are several potential uses of the combined blowing conditions, 1604, 1606, with regards to an aerodynamic surface, such as an aircraft wing or wind turbine blade 100. In one embodiment, the equal blowing rate scenario can be used to effectively create a jet thruster to assist in creating a yawing moment in fixed wing aircraft. In another embodiment, the equal blowing rate scenario creates a rotational torque 116 about the main support shaft 108 of a vertical axis wind turbine to help in the start-up of the turbine.

In one embodiment, differential blowing is used as a pneumatic control surface, i.e. an aileron for a fixed wing aircraft, to increase and decrease the lift force depending on the input parameters to the circulation control system 200, 300. The ability to adjust the direction of the lift force provides several advantages for the application of circulation control in vertical axis wind turbines. One advantage is to enable an augmented performance profile by enhancing the torque 116 generation or creating an aerodynamic brake by providing a lower torque 116 from the turbine blades than that required by the generator to maintain the operating rotational speed 114, a net negative torque 116 about the main support shaft 108 of the wind turbine. The lower aerodynamic created torque 116 can be accomplished by either reversing the direction of the force(s) being created and/or altering the schedule of when the blowing slots 102 are activated during a rotation or complete revolution of the turbine.

Another advantage in applying the dual directional blowing is the ability to alter the structural loading profile of the turbine blade 100. As the stress increases the circulation control scheduling can be altered to limit the stresses at specific locations, such as the attachment points of the support structure 112.

### Blowing Slots

For aircraft applications, circulation control is accomplished by simply pumping air into the wing and thus out of the blowing slot 102 for a length of time. However, for a VAWT the blowing slots 102 are opened and closed in quick succession depending on the instantaneous orientation of the airfoil 100 relative to the wind 104. Circulation control is adapted for the conditions typical of a VAWT, for example the large blade angle of attack 320 and low tip speed ratios 324 (less than 4) that are typical of VAWT. The circulation control system 200, 300 for a VAWT implements a control scheme for controlling the air flow through the blowing slots 102 to generate the maximum power output for the VAWT. The terms blowing slot 102 and air flow slot are therefore used interchangeably in this disclosure.

Referring now to FIG. 18, in one embodiment, to achieve a suitable response time for controlling the air flow, the valve system 1202 is positioned in the interior of the turbine blade, between span-wise 106 spaced rib element 1702 sections of the turbine blade, dividing the length of the turbine blade 100 into multiple blowing slots 102 between rib element(s) 1702. Multiple blowing slots 102 enable a higher level of control over the amount of total air flow required. Each of the valves 1204 is modulated between wide open, fully closed, as well as cycling at various frequencies. In one embodiment, a valve 1204 is located within the turbine blade 100, in close proximity to the blowing slot 102, and positioned at least 75% of the chord length from the leading edge 1704 of the airfoil 100. This proximity to the blowing slot 102 and positioning near the trailing edge 1706 of the airfoil 100 permits a rapid response time for controlled opening and closing of the blowing slots 102 to produce a desirable level of performance of the circulation control augmented VAWT.

Referring now to FIG. 18, in one embodiment, the valve 1204 contains a fixed wall section 1802 that creates a plenum between itself and the blowing slot 102. In one embodiment, this fixed wall section 1802 is integrated as part of the structure for the turbine blade 100. In one embodiment, the fixed wall section 1802 supports a sliding plate 1804 that has the ability to slide in the span-wise 106 direction. The sliding plate 1804 and the fixed wall section 1802 have slots 1806, or a series of holes, milled out of them that are aligned in a manner that allows for full-flow, no-flow and any variable flow condition to be selected between, by sliding the sliding plate 1804 linearly in the span-wise 106 direction. In one embodiment, further enhancement of the circulation control wind turbine is achieved through the use of dual upper blowing slots 1206 and lower blowing slots 1208 placed near both the leading edge 1704 and the trailing edges 1706 of the airfoil 100. In another embodiment, two separate sliding plates 1804, one sliding plate 1804 for the upper air flow slot and a second sliding plate 1804 for the lower air flow blowing slot 102, allow independent control of the air flow blowing slots 102.

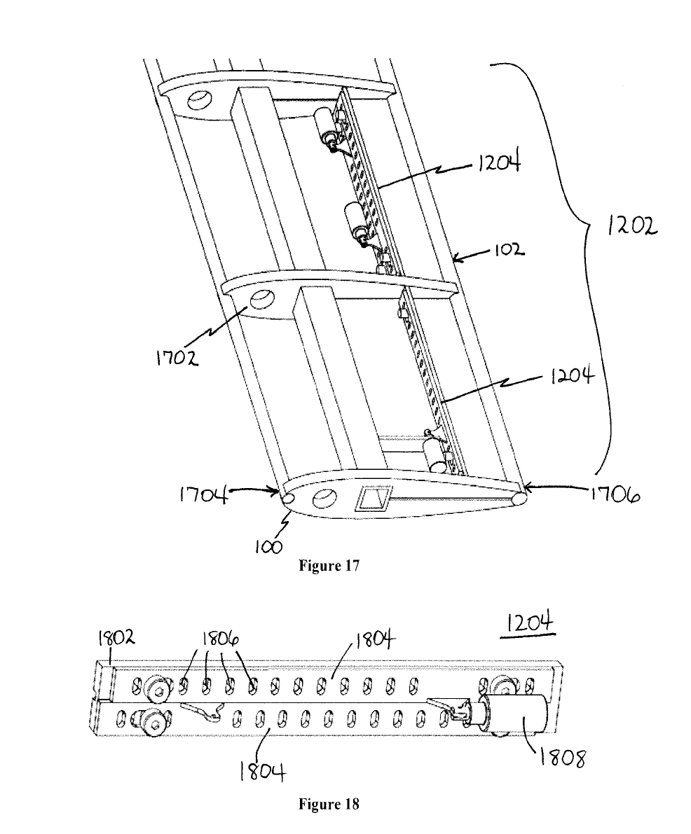

Referring back to FIG. 17, in embodiments, the valve system 1202 maintains an elevated pressure. For efficiency, a quality seal is established between the sliding plate 1804 and the fixed wall section 1802, as well as other portions of the airfoil 100 to prevent leakage. Those skilled in the art will be able to maintain tight manufacturing tolerances and apply sealant around necessary joints. The sliding plate 1804 is pressed flush against the fixed wall section 1802. In one embodiment, the pressure differential between the plenum and air pressure in the blowing slot 102 assists in pressing the sliding plate 1804 against the fixed wall section 1802. In one embodiment, the circulation control system 200, 300 has less than five percent leakage (measured by mass flow of air when closed divided by mass flow of air when fully open), although in other embodiments that circulation control system 200, 300 maintains effectiveness with leakage levels as high as 20 percent.

Referring to FIGS. 17 and 18, the actuation of the sliding plate 1804 is controlled using a solenoid 1808. In various embodiments, the sliding plate 1804 is actuated by any number of devices including, but not limited to, solenoids 1808, linear servo motors, shape memory alloy (SMA) devices, piezoelectric actuators and rotary motors coupled with gears and any linkage(s) and mechanism(s). The choice of actuator is largely based on the specific design constraints for a given VAWT, with response time, size and weight being the dominant considerations for choice of actuator.

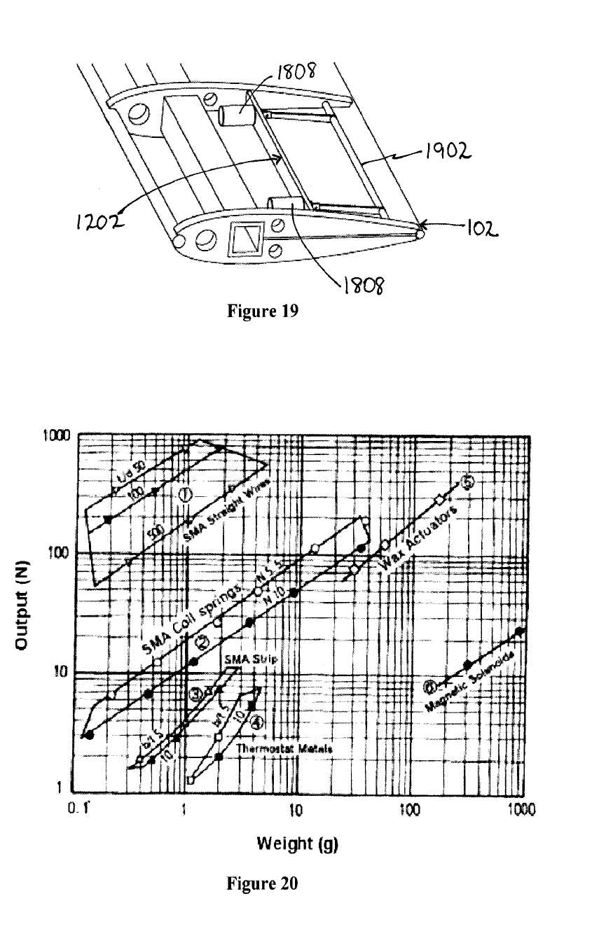

Referring to FIG. 19, an alternate embodiment of a valve system 1202 is presented. In embodiments, one or more solenoids 1808 are coupled to a sealing rod 1902 that seals the blowing slot 102. In these embodiments, the solenoids 1808 retract the linkages 1904 and the sealing rod 1902, allowing allow air to flow past the sealing rod 1902 and out of the blowing slot 102. In order to close the blowing slot 102, the solenoid 1808 pushes the sealing rod 1902 back up against the blowing slot 102 to create a seal.

### Shape Memory Actuators

Circulation control is achieved by selectively opening and closing the blowing slots 102. The blowing slots 102 are opened and closed using actuators, which in some embodiments are solenoids 1808. Mechanical cams, solenoids 1808, and piezoelectric valves can be used to control the flow of air to the blowing slot 102, for example, by attaching them to shutters, louvers, flaps, valves and other mechanisms. But generally these mechanical and electromechanical means have relatively slow reactions times as well as size and weight considerations that substantially impact any airfoil designs that utilize them.

In embodiments, a shape memory actuator is used to selectively open and close a blowing slot 102. Actuators that are capable of converting thermal energy to mechanical energy in the form of force, displacement or torque are referred to as thermal actuators. Shape memory actuators 2100 are a subset of these actuators that use the shape memory effect to generate the desired force and motion.

Referring now to FIG. 20, a comparison of the weight-to-force characteristics of common actuators and shape memory actuators is presented. Shape memory actuators 2100 present practical advantages over the more commonly used mechanical or electromechanical actuators such as solenoids and piezoelectrics, especially in devices under 1 g in weight that are capable of generating over 50 N of actuation force. These advantages are due to the characteristics of the shape memory materials used in the actuators. Shape memory actuators 2100 outperform other means of actuation in both the force and range of motion. Shape memory actuators 2100 allow designers the ability to use smaller actuators with an equivalent amount of force, creating a faster reaction time. Shape memory actuators 2100 are not limited to either linear or rotary motion like most other actuators. In one embodiment, the shape memory actuator 2100 is incorporated into the “skin” of the airfoil. In various embodiments, the shape memory actuators 2100 are designed to operate in tension, compression, torsion, and in more complex configurations to achieve three dimensional motion in any combination of direction(s). In various embodiments, the geometric and spatial orientations of the SMA are used to control the actuation characteristics of the SMA. In various embodiments the SMA material is tubular, or has a cross-section of a circle, an ellipse, a rectangle, or any irregular or regular shape. In various embodiments, the multiple SMA wires are bundled together, for example into strands, ropes, arrays or other shapes. In this embodiment, the SMA bundles can be configured to generate substantially continuous motion or generate increased force output.

Shape memory materials are a class of “smart” materials that have the ability to store a deformed shape and recover the original shape without affecting the structural integrity of the material. In various embodiments, the shape memory material is NiTi, CuAlNi, CuAl, CuZnAl, TiV, or TiNb. In other embodiments, the SMA is incorporated into a ferromagnetic shape memory alloy (FMAS) composite, for example by layering the shape memory material in grooves or indentations in iron or FeCoV alloys. The shape memory effect is an ability to recover, upon heating, mechanically induced strains, resulting in a transformation to a predetermined position. This effect is thermally driven and hinges on a critical temperature, the transition temperature for polymers and the reverse transformation temperature for alloys. These temperatures vary with the material type and loading of the material. Although the polymers can recover much larger strains than alloys, they generally do not produce enough recovery force to be used for most actuators. On the other hand, when constrained to prevent the shape memory effect, some shape memory alloys can generate stresses up to 700 MPa making them effective as actuators.

The shape memory effect occurs in specific alloys because of their ability to transform austenite to martensite (phases of their crystalline structure), a process that naturally occurs in steels and other metals with a carbon content when they are rapidly cooled. However, shape memory alloys are also able to reverse the process, from martensite back to austenite, allowing the alloy to have a memorized “parent” shape. At lower temperatures the alloy can be manipulated because the atoms move cooperatively allowing for variants of the parent phase, but when the temperature is raised above a certain point the martensite becomes unstable and reverse transformation occurs and the alloy reverts back to its parent phase.

Shape memory alloys (SMA) have a natural one way actuation; a pre-stretched wire will contract upon heating above the reverse transformation temperature. The wire will not ‘re-stretch’ upon cooling so in order for the alloys to be used for two way actuators they are used in conjunction with an external force that resets the alloy during cooling. Because the wire will not ‘re-stretch’, two main design embodiments are presented for two-way motion shape memory actuators: (1) in one embodiment, a differential method is utilized and (2) in another embodiment a biasing method is utilized. The differential embodiment provides more precise control of motion whereas the biasing embodiment gives more flexibility in the design of the shape memory actuator 2100.

The differential embodiment uses two shape memory elements that are heated separately. Upon heating, one pre-stretched actuator contracts and stretches the other shape memory actuator preparing it to be heated in the return portion of the cycle. In one embodiment of the differential method, ribbons of SMA are placed on either side of a freely rotating pivot point to create two-way differential actuation.

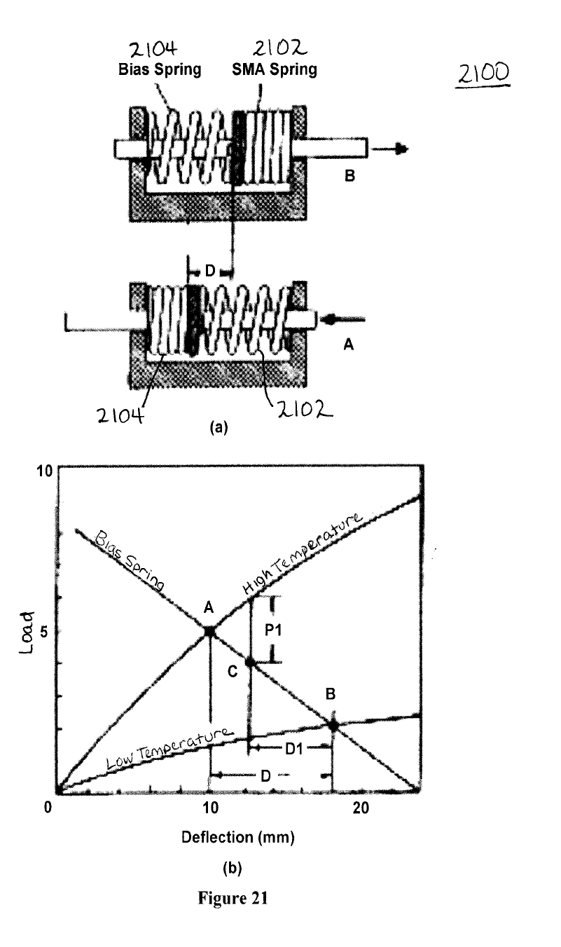

Referring now to FIG. 21, an embodiment of a shape memory actuator 2100 using the bias method is presented. The bias method uses a force-creating component such as a bias spring 2104, elastic member, or dead weight to re-stretch the shape memory component 2102. In one embodiment of the bias embodiment, FIG. 2 shows the relationship between the load deflection curves and the two-way motion of the shape memory actuator 2100. At points A and B, the opposing spring forces are equal defining the total compressed length of the shape memory actuator 2100. The stroke length D is generated as the shape memory actuator 2100 is heated and cooled between these two points. In one embodiment, the shape memory component 2102 is operated under an additional external force, illustrated above as P1, and the stroke is proportionally shortened to D1. The bias spring 2104 stiffness modifies the temperature response, in particular the transformation temperature, the available force, and the hysteresis. In various embodiments, the bias spring 2104 stiffness can essentially be chosen to be any value since it directly affects the operating characteristics of the shape memory actuator 2100. However, in one embodiment the bias spring 2104 stiffness is selected to be equal to the stiffness of the shape memory component 2102 at a low temperature.

In various embodiments, the temperature of the SMA actuator is controlled. In one embodiment, the SMA actuator is thermally shielded. In another embodiment, the SMA actuator is cooled by a cooling system. In another embodiment, the SMA actuator is air cooled.

### Joint for Fluid Delivery

Circulation control on a wind turbine utilizes air that is pumped in and/or out of blowing slots 102 in the turbine blades 100. Incorporating circulation control on a rigidly designed turbine, such as a vertical axis wind turbine or VAWT, with rigid solid connections between the support structure 112 and the blade 100 can be implemented by an air, or similar fluid, circulation control system 200, 300 that uses the main support shaft 108 and support structure 112 support arms as a conduit for passing air to the turbine blades 100. Alternatively, an air flow circulation control system 200, 300 is contained entirely within the turbine blades 100. FIGS. 11, 12, 13, 14, and 15 are illustrations of fan 1104 and piston 1302 type systems in which the air flow is developed within the blade 100 or support structures 112 instead of being provided from an external source.

The use of moveable connections on a dynamically soft turbine reduces the stress concentrations associated with rigid connections of a rigidly designed turbine. Reducing stress concentrations enables a turbine, such as a VAWT, to be constructed that will be both lighter and have a longer fatigue life. However, on a dynamically soft turbine, the sliding or pivoting pinned connection between components creates an impediment to using the turbine support structure 112 members as conduit(s) to pass air into the blade 100. One solution is to incorporate a “jumper” hose that circumvents air around the pinned connections and pneumatically connects the turbine support structure to the blade 100. However a jumper hose creates other problems including, but not limited to, the production of unwanted aerodynamic forces. One aspect of the disclosure is the design of a pinned connection which allows any gas or fluid, referred to as air for simplicity, to pass directly through the pinned joint eliminating the need for a bypass hose, or jumper hose, around the pinned connection.

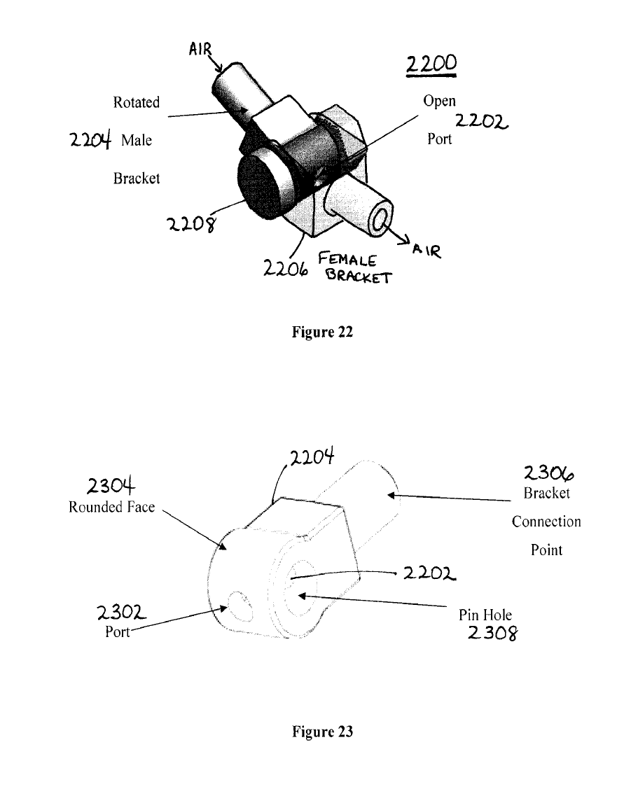

Referring now to FIG. 22, in embodiments, a three component pinned connection system 2200 comprises an air channel 2202 that supplies air from the circulation control system 200, 300 to the blade 100 through the support structure 112 using the air channel 2202. The three component pinned connection system 2200 comprises a male bracket 2204 attached to either of the structural members, with a female bracket 2206 attached to the other structural member, and a pin 2208 connecting the two brackets 2204, 2206 together. A distinguishing feature of this disclosure is that each of the three components has the ability via a port, or similar conduit structure, to allow air or fluid to pass directly through the joint.

Referring now to FIG. 23, in embodiments the male bracket 2204 comprises a rounded face 2304 adapted to be inserted into a female bracket 2206, a hole 2302 into which a pin 2208 can be inserted, and a hollow port 2302. The hollow port 2302 creates part of the air channel 2202 which extends from the male brackets' 2204 connection point 2306 to the support arm support structure 112 through the pin hole 2308 and through the rounded face 2304. The bracket connection point 2306 can be any number of configurations, from a threaded connection or a flat face which can be either welded or bolted to the support arm, or any similar fastening mechanism(s) or means.

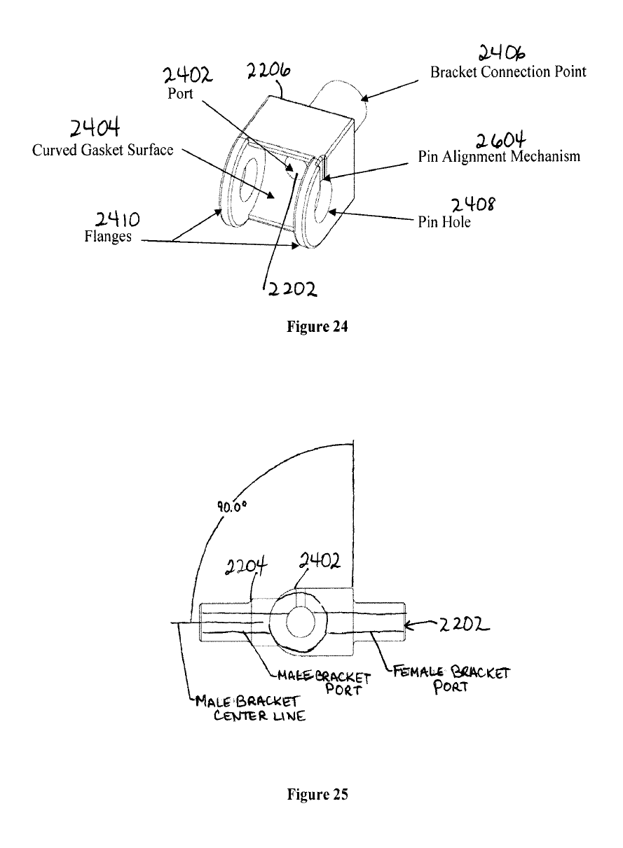

Referring now to FIG. 24, in embodiments the female bracket 2206 comprises two side flanges 2410 between which the male bracket 2204 can be inserted, and a rounded internal face 2404 to mate up with the rounded face 2304 on the male bracket 2204. This rounded internal face 2404 may be coated with a sealing gasket made of rubber, Teflon, or any other material capable of maintaining an air-tight, or near air-tight seal between the mating surfaces 2304, 2404. The side flanges 2410 of the female bracket 2206 contain a pin hole 2408 that when lined up with the pin hole 2308 on the male bracket 2204 enable the pin 2208 to be inserted through the three component pinned connection system 2200 assembly. The male bracket 2204 and female bracket 2206 when assembled together with the pin 2208 comprise a joint having a single axis of rotation, or one degree of freedom.

Referring now to FIG. 25, in one embodiment, the port 2402 is oriented in such a manner that when the centerline of the male bracket 2204 is aligned, positioned at a 90 degree angle to the back surface of the male bracket 2204, the ports 2302, 2402 on both the male bracket 2204 and female brackets 2206 are aligned.

Referring again to FIG. 24, a port 2402 allows fluid or air to flow through the female bracket 2206 and run through the rounded internal face 2404 to the back side of the female brackets' 2206 connection point. In various embodiments, one of the side flanges 2410 on the female bracket 2206 contains either a slot, pinned, or threaded region for the purpose of attaching to the pin 2208 flange in order to prevent the pin 2208 from rotating within the assembled male bracket 2204 and female bracket 2206.

In embodiments, a series of holes around the pin 2208 allow the pin to rotate while maintaining the fluid connection between the male bracket 2204 and female bracket 2206. This can also be achieved by making the male bracket 2204 and female bracket 2206 larger than required by the size of the pin 2208, allowing for the fluid to flow around the pin 2208, in which case an external seal may be utilized to prevent excessive losses in the system. The female bracket 2206 connection point 2406 is created using any number of configurations, from a threaded connection or a flat face which can be either welded or bolted to the turbine blade, or similar fastening mechanism(s).

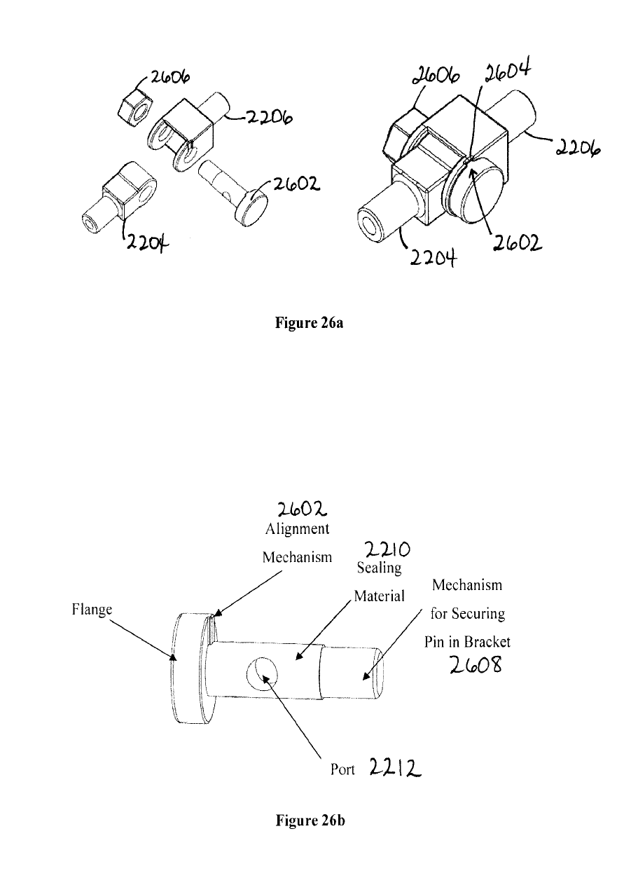

Referring now to FIGS. 26a and 26b, in one embodiment, the pin 2208 comprises a solid cylinder encased in a sealant material 2210 which will provide an air tight seal between the pin 2208 surface and surfaces 2304, 2404 of the male and female brackets 2204, 2206. On one end of the pin 2208, a flange with an alignment mechanism 2602 mates with pin alignment mechanism 2604 on the female flange 2410 to prevent the pin 2208 from rotating within the pin holes 2308, 2408. The opposite end of the pin 2208 contains a mechanism for securing 2608 the pin within the pin hole, such as a cotter pin or threads onto which a fastener 2606 can be installed so that the pin 2208 is prevented from losing connection and alignment during operation. The pin 2208 also contains a port 2212, or series of ports 2212, through it which are oriented such that when the alignment mechanisms on the pin 2208 and female flange 2410 are mated; the ports 2212 are aligned with the port 2302 on the female bracket 2206.

While the ports 2302, 2212 on both the pin 2208 and female bracket 2206 are continuously aligned due to the alignment mechanism, the male bracket 2204 is free to rotate about the pinned 2208 axis for a finite number of degrees while still allowing the fluid access to the pin 2208 and female bracket 2206 ports 2302, 2212. Passage of fluid through the joint is dependent on the angular displacement of the ports 2302, 2402, 2212 relative to one another and the size of the ports 2402, 2304, 2212, with larger ports 2302, 2402, 2212 permitting larger angular variations.

In other embodiments, altering the shape of the ports 2302, 2402, 2212, to oval for example, extends the angular displacement while maintaining pneumatic or similar fluid dynamic flow capability. By varying the arc length of the rounded face of the male bracket 2204, the connection is designed to limit the joint to rotating within a desired range. In embodiments, in addition by varying the arc length on the rounded face of the male bracket 2204 and/or varying the port 2302 diameter, the connection is designed to only allow fluid to pass through the channel 2202 during a desired range of rotation. It is important to note that the port 2302 diameter does not exceed the diameter, height, or width of the bracket 2204, 2206 connection point and still maintain a sealed channel 2202 through which fluid can pass.

Design equations relating the range of operation of the joint mechanism to the face arc length and radius and port diameter are as follows.

Length of curvature of male bracket face for desired range of joint operation (Rⱼ):

l=r(π+Rⱼ) [1]
l=length of curvature of male bracket face
Rⱼ=desired range of joint operation
   Range of port hole operation based on port hole diameter.

$${R}_{p} = 4 {sin}^{- 1} ( \frac{d}{2 r} ) \qquad [ 2 ]$$

Rₚ32 range of port hole operation
d=port hole diameter
r=radius of curvature of the male bracket face
   The maximum port hole diameter as a function of desired range of joint operation.

$${d}_{max} = 2 r sin ( \frac{π}{2} - \frac{{R}_{j}}{2} ) \qquad [ 3 ]$$

dₘₐₓ=maximum port hole diameter
r=radius of curvature of the male bracket face
Rⱼ=desired range of joint operation
   Range of operation of port hole

$${R}_{p} = 4 {sin}^{- 1} ( \frac{d}{2 r} ) \qquad [ 4 ]$$

d=port hole diameter
r=radius of curvature of the male bracket face

### Constant Rate Circulation Control Method

In embodiments, two additional blowing schemes are presented. The first blowing scheme implements a constant blowing coefficient and the second blowing scheme implements a constant blowing rate. The proper selection of the blowing coefficients Cμ 412 for use on a CC-VAWT is complex and depends on the physical size of the turbine, the wind speed 308, rotational speed 114 and the rate at which momentum is introduced from the blowing slot, with a maximum rate of momentum of 30 kg-m/s2 per meter span of the blade 100. The maximum benefit from an energy perspective has been predicted to occur with a blowing coefficients Cμ 412 of 0.10 or less, thus this value has been used in various embodiments, however other blowing coefficients Cμ 412 are also contemplated. At nominal wind conditions, the blowing coefficients Cμ 412 uses a jet momentum blowing rate of no more than 30 kg-m/s2 per meter in span 106 of the turbine blade 100 utilizing the circulation control blowing. The blowing coefficients Cμ 412 is a design decision to be made based on the environmental conditions of the location wherein said VAWT is to be constructed. Thus, the constant blowing rate is varied from turbine to turbine resulting in a wide range of blowing coefficients Cμ 412 as the wind speed 308 and tip speed ratio 324 are varied.

The blowing coefficients Cμ 412, as defined in Eq. [5], is a function of the jet properties of mass flow rate and velocity as well as the relative velocity 322 of the wind speed 308, density and area of the turbine blade 100. Thus, maintaining a constant blowing coefficients Cμ 412 is difficult and can result in large power requirements. In one embodiment of the VAWT, a constant blowing rate of \dot{m}Vⱼ is used. But the determination of the most efficient blowing rate is dependent on the wind 104 conditions at the site of the wind turbine and the desired size of the turbine.

$${C}_{μ} = \frac{{\dot{m}}_{j} {V}_{j}}{\frac{1}{2} ρ {A}_{w} {V}_{∞}^{2}} \qquad [ 5 ]$$

The specification of the constant blowing rate needed for the circulation control augmented vertical axis wind turbine (CC-VAWT) is a design choice based on the environmental conditions and the parameters of the turbine, such as turbine size. Two additional factors, the tip speed ratio 324, λ, and the turbine rotor solidity factor 1000, σ, affect the blowing rate requirement. These parameters are chosen by examining several Cp-curves. The non-dimensional parameter of tip speed ratio 324 is the ratio of rotational speed to free stream velocity and impacts the coefficient of performance Cp 410, of the wind turbine. Referring again to FIGS. 8 and 9, performance projections are illustrated for constant blowing coefficient values 802 applied throughout a range of tip speed ratios 324 using the momentum models 800 and vortex models 900. FIG. 8 is an example of a predicted non-dimensional performance curve for a vertical axis wind turbine with a solidity factor 1000, as defined in Eq. [6], of 0.05 for various blowing coefficients, Cμ 412, based on performance at a specific Reynolds number, Eq. [7], of 360,000. FIG. 8 shows the performance for the case when the blowing coefficient, Cμ 412, is maintained at a constant value through the speed range which in one embodiment is a circulation control blowing strategy implemented for the CC-VAWT.

$$\begin{matrix}σ = \frac{N c}{r} & [ 6 ] \\ Re = \frac{ρ {V}_{r} c}{μ} & [ 7 ]\end{matrix}$$

In an alternate embodiment, one tip speed ratio is selected for maximum coefficient of performance or some other criterion of optimal performance, Cₚ 410, and prescribes the blowing rate required to achieve this optimum blowing coefficient, C_{μ}, 412, for example less than 0.20 for reasonable operating conditions and tip speed ratios 324 significantly above one.

Wind classifications such as the Beaufort scale, shown in Table 1, determine typical speeds for various wind descriptions and the operational wind speeds of a CC-VAWT. Generally the wind turbine will be shut down, for structural safety reasons, in and above “Strong Gale” wind conditions, while operating in winds in the Beaufort classifications of 2 through 8. To obtain a range of blowing rates for the CC-VAWT, the blowing coefficient of 0.10 is selected at a tip speed ratio 324 of 1.0 and 6.0 and a variety of wind speeds. The three wind speeds that were used are Beaufort classifications 3 (4 m/s), 4 (7 m/s), and 6 (12 m/s).

TABLE 1
Beaufort Wind Speed Scale

| | Wind speed | | | |
|---|---|---|---|---|
| Beaufort # | km/h | mph | m/s | Description |
| 0 | <1 | <1 | <0.3 | Calm |
| 1 | 1-5 | 1-3 | 0.3-1.5 | Light air |
| 2 | 6-11 | 3-7 | 1.5-3.3 | Light breeze |
| 3 | 12-19 | 8-12 | 3.3-5.5 | Gentle breeze |
| 4 | 20-28 | 13-17 | 5.5-8.0 | Moderate breeze |
| 5 | 29-38 | 18-24 | 8.0-10.8 | Fresh breeze |
| 6 | 39-49 | 25-30 | 10.8-13.9 | Strong breeze |
| 7 | 50-61 | 31-38 | 13.9-17.2 | High wind |
| 8 | 62-74 | 39-46 | 17.2-20.7 | Fresh Gale |
| 9 | 75-88 | 47-54 | 20.7-24.5 | Strong Gale |
| 10 | 89-102 | 55-63 | 24.5-28.4 | Whole Gale/Storm |
| 11 | 103-117 | 64-72 | 28.4-32.6 | Violent storm |
| 12 | >118 | >73 | >32.6 | Hurricane-force |

The blowing rate, \dot{m}Vⱼ of Eq. [5], requirements are determined for the median wind velocity of 7 m/s, which at a tip speed ratio 324 of 1.0 and a chord 502 length of 0.2 m results in a jet velocity of 63.7 m/s and a 1.7 kg-m/s² per meter blowing rate. Similarly, specifying a blowing coefficient of 0.1 to occur at a tip speed ratio 324 of 6 results in a jet velocity of 222.9 m/s and 30 kg-m/s² per meter. Thus, the maximum value for the blowing rate is 30 kg-m/s² for every meter in span 106 of the blade 100, for example a 3 meter tall blade 100 requires no more than 90 kg-m/s of air, or similar gas or liquid.

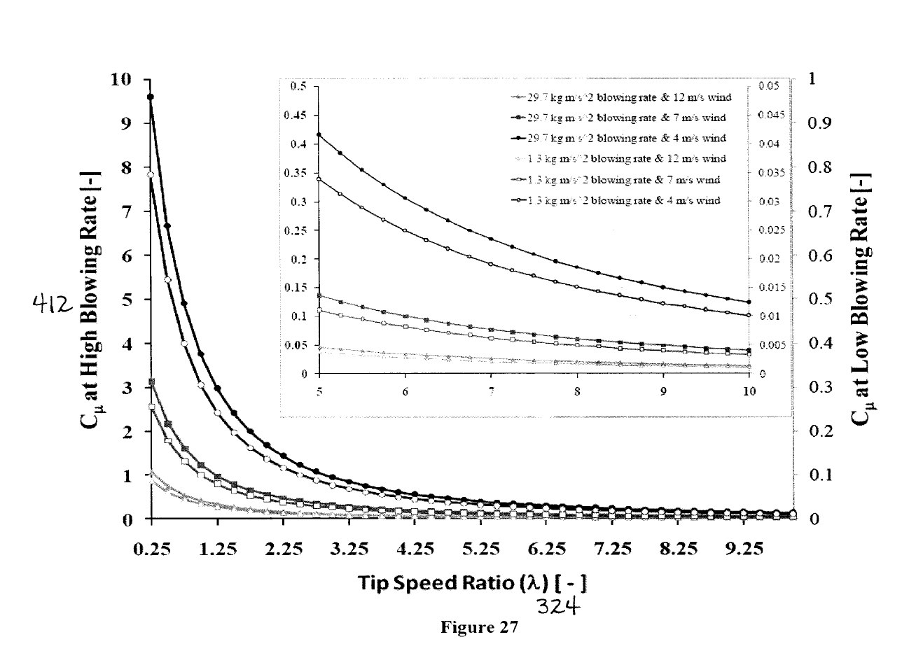

Referring now to FIG. 27, an illustration shows the influence that tip speed ratio 324 has on the blowing coefficients, Cμ 412, when using a constant jet momentum rate. It is important to note that a change in the length (or span 106) of the blade 100 requires a change in the total jet momentum rate.

### Circulation Control to Regulate Environmental Effects Method

One benefit of an active system is the ability to alter the effectiveness of the augmentation based on wind speed 308 and blade direction. Thus, the circulation control lift increase can be reduced for higher wind speeds, providing a lower torque 116 and thus providing a way to limit the rotational speed 114 of the system. Both, active and passive circulation/flow control systems can be utilized to change the aerodynamic coefficients of a lifting surface and thus alter its performance. The power generated by a wind turbine is related to the rotational speed 114 and torque 116 at the main support shaft 108. By favorably altering the lift coefficient of the turbine blades 100 to increase the torque 116 being supplied to the turbine main support shaft 108, a larger generator and/or a larger gear ratio can be used to increase the electrical power generated. The augmented torque 116 generated, particularly at lower speeds, could also be used to extend the operational wind speed range of the turbine by enabling the production of power at a lower wind speeds 308. The maximum safe wind speed 308 can also be increased by removing the augmentation, resulting in a reduction in the torque 116 that is generated. An alternative modification to the turbine would be to reduce either the chord 502 of the turbine blade 100 or the radius 312 of the turbine while maintaining an equal power output in currently used systems with circulation control augmentation.

The addition of a feedback control system allows the turbine to respond to changes in wind speed 308, mitigating the effects of wind 104 gusts, to maintain a relatively constant torque 116 and/or rotational speed 114 to the generator main support shaft 108. Providing a constant rotational speed 114 to the generator decreases the fluctuating stress in the major components (transmission, generator, etc), increasing the expected life of the respective parts. The connection of the CC-VAWT to an existing electrical grid is also made easier with the constant shaft speed because the controller can be programmed such that the specified frequency (i.e., 50/60 Hz) of AC power can be generated.

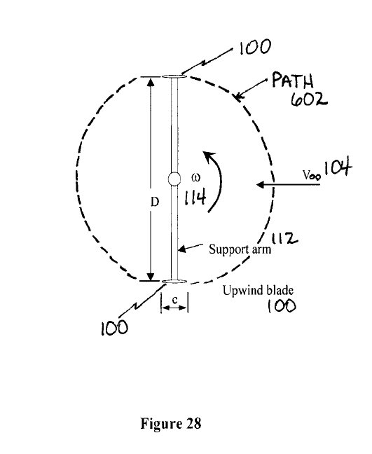

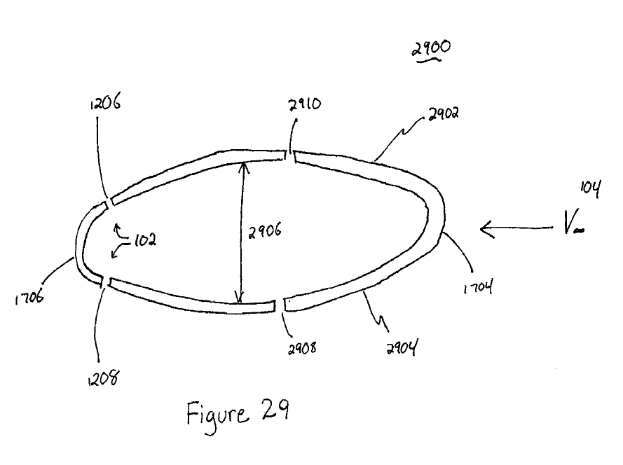

Referring now to FIG. 28, one embodiment of the circulation control augmented wind turbine, or CC-VAWT, is a structure having the solidity factor 1000, σ, as defined in Eq. [6], based on the number of blades 100, N, the blades' 100 chord 502 length, c, and the turbine radius 312, r, of less than 0.30 and incorporates at least one blowing slot 102 located either near the trailing edge 1706 (location to chord 502 length ratio (x/c)>0.75) or in front of the location of maximum thickness (0.20<x/c<0.50 typically) on either the upper or lower (or inner and outer) surface of the turbine blade 100. The addition of a second blowing slot expands the augmentation capabilities of the circulation control system. FIG. 28 shows a two-bladed 100 wind turbine for convenience only, circulation control augmentation can be applied to a wind turbine with any number of blades 100.

The cyclic use of circulation control applied to each blade 100 as it goes around its rotational path 602 alters the interaction of the wind turbine with the naturally occurring wind 104. The optimum and most efficient amount of augmentation applied to the blades 100 is also dependent on the wind speed 308, V. In embodiments, presented are several strategies for cyclic application of circulation control to the blades 100 of a vertical axis wind turbine. Referring also to FIG. 6a, a first embodiment employs a strategy of cyclic blowing on one span-wise 104 distributed blowing slot 102 location that is utilized when the blade 100 is in the downwind half of the profile, and no blowing during the upwind half of the profile.

Referring now to FIG. 29, a top view of one embodiment of a symmetric airfoil blade 2900 is presented indicating alternative blowing slot 102 locations. In alternate embodiments, the airfoil 100 could be cambered. In particular, the symmetric airfoil blade 2900 comprises a single upper blowing slot 1206, on the outer surface 2902 and near the trailing edge 1806 of the symmetric airfoil blade 2900, that is downwind of the wind direction 302, V. In an alternative embodiment, a single lower blowing slot 1208 on the inner surface 2904 of the symmetric airfoil blade 2900 near the trailing edge 1706 is presented.

In another embodiment, the blowing scheme is to use two different blowing slots 102, an upper blowing slot 1206 on the outer surface 2902 and near the trailing edge 1806 of the symmetric airfoil blade 2900, and a second lower blowing slot 1208 on the inner surface 2904 of the symmetric airfoil blade 2900 near the trailing edge 1706. The use of the second blowing slot 102 is most useful for force augmentation with a symmetric airfoil blade 2900 shape due to the uniform force augmentation in both directions (inward and outward). This scheme uses the upper blowing slot 1206 of the outer surface 2902 during a portion of the rotational path 602 of the symmetric airfoil blade 2900 (while the second lower blowing slot 1208 is not used), and then the lower blowing slot 1208 of the inner surface 2904 is used (while the first upper blowing slot 1206 is not used) during the remainder of the blades' rotational path 602; essentially inverting the lift force, providing more control over the instantaneous torque 116 being produced.

The upper blowing slot 1206 and lower blowing slot 1208 are used as needed for efficient and maximum performance of the wind turbine. For example, in one embodiment, the upper blowing slot 1206 on the outer surface 2902 is used in the upwind (into the wind 104, V) portion of the symmetric airfoil blade's 2900 rotational path 602 while the second lower blowing slot 1208 on the inner surface 2904 is used in the downwind (with the wind 104, V) portion of the symmetric airfoil blade's 2900 rotational path 602. In an alternative embodiment, the upper blowing slot 1206 is used in the downwind portion of the path 602 of the symmetric airfoil blade's 2900 rotational path 602 and the second lower blowing slot 1208 is used in the upwind portion of the symmetric airfoil blade's 2900 rotational path 602. In still another embodiment, both the upper blowing slot 1206 and lower blowing slot 1208 are used to maximize performance, such as in high winds 104 when extra control of the symmetric airfoil blade 2900 is required.

In other embodiments, a pair of secondary blowing slots 2902, 2904 disposed in front of the location of maximum thickness 2906 on either the outer surface 2902 or inner surface 2904 of the symmetric airfoil blade 2900. These secondary blowing slots 2902, 2904 are used in a similar manner as the upper blowing slot 1206 and lower blowing slot 1208 such that each secondary blowing slots 2902, 2904 can be used independent of or in conjunction with the other secondary blowing slots 2902, 2904. Further, the secondary blowing slots 2902, 2904 on a symmetric airfoil blade 2900 expands the augmentation capabilities of the wind turbine when used in concert with the upper blowing slot 1206 and lower blowing slot 1208 as described above.

In yet another embodiment, the symmetric airfoil blade 2900 may have one or more blowing slots (not shown) near the leading edge 1704 of the blade, wherein such blowing slots 102 may be on the outer surface 2902 or the inner surface 2904 of the symmetric airfoil blade 2900. In an embodiment, these blowing slots 102 are similar to the blowing slots 102 disclosed in U.S. patent application Ser. No. 11/387,136 (which is incorporated in its entirety by reference), and where there is a small step in the blade 100 surface near the jet that is before the maximum thickness 2906.

The use of circulation control for vertical axis wind turbines adds the complexity of cycling the blowing rate. The optimal performance, based on the power generation over a range of wind speeds, of the turbine requires the varying of the aerodynamic performance characteristics of the blade 100 depending on the blade rotational position 304 relative to the wind 104, and the rotational speed 114 of the turbine. Using the non-dimensional rotational speed, or tip speed ratio 324, λ, as defined in Eq. [8] a preliminary analysis was conducted of the performance alterations that circulation control provides to a wind turbine. Applying a circulation control blowing rate to the blade of a VAWT results in an increase in the coefficient of performance, Cₚ 410, which is a measure of the energy extracted from the wind, which cannot exceed the theoretical upper limit of 16/27≅0.59, the Betz limit.

$$λ = \frac{ω r}{{V}_{∞}} \qquad [ 8 ]$$

For this analysis the turbine blade rotational path 602 was divided in half with the blowing on the inner surface 2904, near the trailing edge 1706, of the turbine blade 100 when the blade 100 is on the half of the turbine away from the wind 104 (zone 2-B of FIG. 6a) and on the outer surface 2902 of the blade 100 when in the half of the turbine nearest the wind 104 direction (zone 2-A of FIG. 6a) at a solidity factor 1000, σ, of 0.05 and a Reynolds number, Re, as defined in Eq. [7] of 360,000.

Comparing the blowing coefficients of 0, 0.01, and 0.10 as shown in FIG. 8 and FIG. 9, it is seen that increasing the blowing coefficients, Cμ 412, considerably increases the coefficient of performance, Cₚ 410, at tip speed ratios 324 less than six, improving operation at lower tip speeds. By comparing the circulation control performance to the influence of solidity factors 1000, σ, in FIG. 10, it is seen that the use of circulation control resembles increasing the solidity factor 1000, σ. Closer inspection of FIG. 10 reveals that as the solidity factor 1000, σ is increased, by increasing either the number of blades 100 or the size of the blades 100, or reducing the radius 312 of the wind turbine, up to a σ of 0.4, the maximum coefficient of performance, Cₚ 410 is increased and occurs at a lower tip speed ratio 324. However, at higher tip speed ratios 324, the performance of low solidity factors 1000, σ, becomes better than at high solidity factors 1000, σ. Thus, a design decision is required to determine the preferred solidity factor 1000, σ, and tip speed ratio 324. For a conventional VAWT the solidity factor 1000, σ, cannot be adjusted during the operation of the wind turbine, whereas for a CC-VAWT a change in the circulation control blowing parameters results in an apparent solidity factor 1000, σ, change. Circulation control allows adjustment of the performance of the turbine to achieve the highest possible coefficient of performance, Cₚ 410 at a variety of tip speed ratios 324, which is a function of the rotational speed 114 and wind speeds 308; and with a rapid response control scheme, the ability to adjust performance for gusting winds 104. At high tip speed ratios 324 the turning on of the circulation control system 200, 300 will reduce the power extracted from the wind 104, allowing for safer operation at higher wind speeds 308 than conventional wind turbines.

Referring again to FIGS. 6a, 6b, 6c, and 6d, additional configurations of dividing the blade path 602 into regions or zone results in more efficient performance of the circulation control system 200, 300 by using circulation control only when the performance enhancement in lift increases the torque generated by the turbine. FIGS. 6a, 6b, 6c, and 6d illustrate four potential configurations, the two division section already analyzed, and three, four, and eight divisions per revolution. In embodiments, with faster response times, the blade path 602 is further divided to optimize the performance of a circulation control augmented, vertical axis wind turbine, resulting in near-continuous control by the circulation control system 200, 300.

In embodiments, in addition to varying the circulation control performance with the blade rotational position 304, the blowing coefficient, Cμ 412, is varied with the span 106 of the turbine blade 100. Distributing the blowing in the span-wise 106 direction enables the ability to operate with a portion of the blade 100 making a larger contribution to the forces than other portions of the blade 100. This allows the circulation control system 200, 300 to reduce the stress on the three component pinned connection system 2200 and/or to mitigate the harmonic vibration of the blade 100 near its natural frequency. In embodiments where a constant blowing rate is used for the circulation control system 200, 300, then fractions of the maximum performance can be achieved by activating an equivalent fraction of the blowing slots 102.

### CONCLUSION

While various embodiments have been described above, it should be understood that the embodiments have been presented by way of example only, and not limitation. It will be understood by those skilled in the art that various changes in form and details may be made therein without departing from the spirit and scope of the subject matter described herein and defined in the appended claims. Thus, the breadth and scope of the present invention should not be limited by any of the above-described exemplary embodiments, but should be defined only in accordance with the following claims and their equivalents.

What is claimed is:

1. A circulation controlled vertical axis wind turbine, comprising:
an airfoil having a leading edge, a trailing edge, a blowing slot disposed near said trailing edge, an internal cavity, and a control means for modulating a flow of air between said internal cavity and said blowing slot;
a support structure connected to said airfoil;
a rotatable support shaft connected to said support structure, said support shaft in communication with said airfoil, and wherein said span has approximately the same horizontal orientation as said rotatable support shaft; and
a controller in communication with said control means.

2. The circulation controlled vertical axis wind turbine of claim 1, further comprising:
a sensor in communication with said controller, said sensor providing a sensor indication.

3. The circulation controlled vertical axis wind turbine of claim 2, wherein said sensor indication is selected from the group consisting of an environmental parameter and a system parameter, and wherein said environmental parameter is selected from the group consisting of wind speed, wind direction, temperature, air pressure, and humidity; and said system parameter is selected from the group consisting of rotational speed, torque, and rotational position.

4. The circulation controlled vertical axis wind turbine of claim 2, wherein said controller processes one or more of said sensor indications to produce estimations of angle of attack, relative velocity, and tip speed ratio.

5. The circulation controlled vertical axis wind turbine of claim 4, wherein said controller further comprises a decision matrix adapted to use said estimations to determine in which said blowing slot to modulate said flow of air.

6. The circulation controlled vertical axis wind turbine of claim 1, further comprising:
a source of air fluidly connected through said support structure to said internal cavity of said airfoil.

7. The circulation controlled vertical axis wind turbine of claim 6, further comprising:
a ported pinned connection system for connecting said support structure to said airfoil; and
wherein said ported pinned connection system allows a connection point between said support structure and said airfoil to rotate in at least one-dimension while said source of air remains fluidly connected to said airfoil through said ported pinned connection system.

8. The circulation controlled vertical axis wind turbine of claim 7, wherein said ported pinned connection system is adapted to interrupt said fluid connection through said port for a range of rotation.

9. The circulation controlled vertical axis wind turbine of claim 7, said ported pinned connection system further comprising:
a male joint having a male coupling portion and an attachment portion, said male coupling portion having a first port, and said attachment portion having a second port, said first and second ports in fluid communication;
a female joint having a female coupling portion for accepting said male coupling portion of said male joint, said female coupling portion in fluid communication with said first port of said male coupling portion; and
a pin adapted to secure said male coupling portion to said female coupling portion.

10. The circulation controlled vertical axis wind turbine of claim 7, wherein said pin further comprises:
a port in fluid communication with said first port of said male joint and said female coupling portion.

11. The circulation controlled vertical axis wind turbine of claim 1, wherein said blade further comprises:
a plurality of blowing slots, and
wherein said control means is a valve system comprising a plurality of valves that independently modulate a flow of air between said internal cavity and each of said plurality of blowing slots.

12. The circulation controlled vertical axis wind turbine of claim 1, wherein said blade further comprises:
a suction port for boundary layer control, and
wherein said control means modulates a flow of air between said suction port and said blowing slot through said internal cavity.

13. The circulation controlled vertical axis wind turbine of claim 12, wherein said control means comprises a piston, said piston in pneumatic communication with said blowing slot and said suction port.

14. The circulation controlled vertical axis wind turbine of claim 12, wherein said control means comprises a valve system comprising valves and check valves.

15. A joint assembly for fluid delivery in a circulation controlled vertical axis wind turbine, comprising:
a first bracket member having a hollow connection portion for attaching to a support structure of an airfoil and an open port for fluidly connecting to said second bracket member;
a second bracket member that accepts said first bracket member and fluidly connects an external source of fluid to said open port of said first bracket member; and
a bracket pin for securing said first bracket member to said second bracket member to create the joint assembly for fluid delivery.

16. The joint assembly of claim 15, wherein said first bracket member is a female bracket and said second bracket member is a male bracket.

17. The joint assembly of claim 15, wherein said first bracket member is a male bracket and said second bracket member is a female bracket.

18. The joint assembly of claim 15, wherein said bracket pin further comprises a port through which a fluid passes into said open port of said first bracket member.

19. The joint assembly of claim 15, further comprising:
a support structure of an airfoil having a hollow connection portion for attaching to said first bracket member, said support structure in fluid communication with a airfoil of the circulation controlled vertical axis wind turbine.

20. A circulation controlled vertical axis wind turbine, comprising:
an airfoil having a plurality of blowing slots, an internal cavity, and a valve for selectively modulating a flow of air between said internal cavity and said blowing slot;
a support structure connected to said airfoil at a plurality of support structure connection points along a span of said airfoil, said support structure connecting a source of pressurized air to said internal cavity of said airfoil; and
a rotatable support shaft connected to said support structure, said support shaft in communication with said turbine.
